(19) United States
(12) Patent Application Publication
(10) Pub. No.: US 2023/0182086 A1
(43) Pub. Date: Jun. 15, 2023

(54) HIGH-PERFORMANCE COMPOSITE MEMBRANES FOR GAS SEPARATION

(71) Applicant: Ohio State Innovation Foundation, Columbus, OH (US)

(72) Inventors: W.S. Winston HO, Columbus, OH (US); Ruizhi PANG, Columbus, OH (US); Ting-Yu CHEN, Worthington, OH (US)

(21) Appl. No.: 17/926,473

(22) PCT Filed: Mar. 18, 2021
(86) PCT No.: PCT/US2021/023034

§ 371 Date: Nov. 18, 2022

Related U.S. Application Data
(60) Provisional application No. 63/026,628, filed on May 18, 2020.

(51) Int. Cl. B01D 69/12; B01D 69/02; B01D 71/60; B01D 53/22

(52) U.S. Cl. CPC B01D 69/1214; B01D 69/02; B01D 71/60; B01D 53/228; B01D 2325/36

(57) ABSTRACT

Provided herein are gas permeable membranes comprising an amine-containing selective layer on top of a gas permeable polymer support as well as methods of making and using thereof. The membranes are useful for the separation of CO₂ from N₂-containing gases.

### CROSS-REFERENCE TO RELATED APPLICATIONS

This application claims the benefit of priority to U.S. Provisional Application No. 63/026,628 filed May 18, 2020, the disclosure of which is incorporated herein by reference in its entirety.

### STATEMENT REGARDING FEDERALLY SPONSORED RESEARCH OR DEVELOPMENT

This invention was made with Government Support under Grant No. DE-FE0031731 awarded by U.S. Department of Energy. The Government has certain rights in the invention.

### TECHNICAL FIELD

This disclosure relates to membranes, and more particularly to membranes for gas separation.

### BACKGROUND

There has been growing concern about global warming since the CO₂ concentration in the atmosphere has surpassed 400 ppm in the past decade. The combustion of fossil fuels is one of the major contributors to the large amount of CO₂ emissions, and membrane technologies have been suggested as a promising approach to capture CO₂ from large stationary sources, followed by compression and geological sequestration. As one approach to produce large-scale electricity, coal can be combusted to produce high-pressure steam, which can then be used to produce electricity via steam turbines. Because of the high carbon density of coal, a large amount of CO₂ is emitted in the form of flue gas. Therefore, the CO₂ has to be efficiently separated from N₂ in order to mitigate the overall carbon emissions in the energy sector.

Accordingly, improved methods of separating CO₂ from N₂ are needed. The compositions and methods disclosed herein address it and other needs.

### SUMMARY

Disclosed are membranes and methods of making membranes that include a gas permeable support layer and a selective polymer layer disposed (e.g., coated) on the support layer.

In some embodiments, the membranes can comprise a base, a support layer comprising a gas permeable polymer disposed (e.g., casted) on the base, wherein the support layer has a CO₂ permeance of at least 25,000 GPU at 57° C. and ambient pressure; and a selective polymer layer disposed (e.g., coated) on the support layer, the selective polymer layer comprising a selective polymer matrix.

The gas permeable polymer can comprise, for example, polyamides, polyimides, polypyrrolones, polyesters, sulfone-based polymers, polymeric organosilicones, fluorinated polymers, or polyolefins, copolymers thereof, or blends thereof. In some embodiments, the gas permeable polymer includes polyethersulfone. The base can comprise a nonwoven fabric such as a polyester nonwoven.

The selective polymer matrix can include a hydrophilic polymer, an amino compound (e.g., an amine-containing polymer (a fixed-site carrier), a low molecular weight amino compound (a mobile carrier), or a combination thereof), a cross-linking agent, or a combination thereof. In certain embodiments, the selective polymer matrix can include an amino compound (e.g., an amine-containing polymer, a low molecular weight amino compound, or a combination thereof).

In some embodiments, the selective polymer matrix can include an amine-containing polymer (e.g., polyvinylamine), a hydrophilic polymer (e.g., polyvinyl alcohol (PVA)), a cross-linking agent (e.g., aminosilane), and a low molecular weight amino compound (e.g., piperazinylethylamine-sarcosinate (PZEA-Sar), piperazinylethylamine-aminoisobutyric acid (PZEA-AIBA), hydroxyethylpiperazine (HEP), or a combination thereof). In some embodiments, selective polymer matrix can include an amine-containing polymer (e.g., sterically hindered polyvinylamine), and a low molecular weight amino compound (e.g., PZEA-Sar).

Optionally, graphene oxide can be dispersed within the selective polymer matrix. When present, the graphene oxide can be any suitable form of graphene oxide. In some embodiments, the graphene oxide can be nanoporous. The selective polymer layer can comprise from 0.01% to 5% by weight graphene oxide, based on the total dry weight of the selective polymer layer.

Also provided are membranes that comprise a support layer; and a selective polymer layer disposed (e.g., coated) on the support layer, the selective polymer layer comprising a selective polymer matrix that comprises a sterically hindered amine-containing polymer. The sterically hindered amine-containing polymer can comprise from 5 to 50 mol % secondary amine-containing monomers, based on the total of all amine-containing monomers in the amine-containing polymer.

In some embodiments, the sterically hindered amine-containing polymer can comprise from 45 to 90 mol % primary amine-containing monomers, based on the total of all amine-containing monomers in the amine-containing polymer. In some embodiments, the sterically hindered amine-containing polymer can comprise less than 5 mol % tertiary amine-containing monomers, such as less than 1 mol % tertiary amine-containing monomers or less than 0.5 mol % tertiary amine-containing monomers, based on the total of all amine-containing monomers in the amine-containing polymer. In some embodiments, the sterically hindered amine-containing polymer exhibits a degree of N-methylation degree of from 20% to 50%/o, such as from 30% to 50%.

In certain embodiments, the sterically hindered amine-containing polymer can comprise poly(N-methyl-N-vinylamine) or a copolymer or blend thereof. In certain embodiments, the sterically hindered amine-containing polymer comprises a random copolymer or block copolymer having the structure below

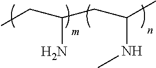

wherein m is an integer from 10 to 10,000; and n is an integer from 10 to 10,000.

The membranes described herein can exhibit selective permeability towards gases, such as carbon dioxide. In certain embodiments, the selective polymer matrix can exhibit a CO₂:N₂ selectivity of at least 80 (e.g., from 80 to 800) at 57° C. and 1 atm feed pressure. In certain embodiments, the selective polymer matrix can exhibit a CO₂:N₂ selectivity of at least 80 (e.g., from 80 to 800) at 97° C. and 6 atm feed pressure.

Also provided are methods for separating a first gas from a feed gas stream using the membranes described. These methods can include contacting a membrane described with the feed gas stream including the first gas under conditions effective to afford transmembrane permeation of the first gas. The feed gas can include hydrogen, carbon dioxide, hydrogen sulfide, carbon monoxide, nitrogen, methane, steam, sulfur oxides, nitrogen oxides, or combinations thereof.

In some embodiments, the first gas is chosen from carbon dioxide, hydrogen sulfide, and combinations thereof. In some of these embodiments, the feed gas can include a second gas such as nitrogen, hydrogen, carbon monoxide, or combinations thereof. The membrane can exhibit a first gas/second gas selectivity of from 20 to 300 at 57° C. and 1 bar feed pressure.

In certain embodiments, the feed gas includes flue gas. The first gas can include carbon dioxide and the second gas can include nitrogen. In these embodiments, the membranes described can be employed, for example, to decarbonize coal-derived flue gas.

Also provided are methods of making a membrane that includes depositing (e.g., coating) a selective polymer layer on a support layer, the selective polymer layer comprising a selective polymer matrix and optionally a graphene oxide dispersed within the selective polymer matrix.

Also provided are methods of making a membrane support layer with a bicontinuous structure (with well interconnected pores but no surface dense layer formation) to prepare more permeable membranes. High performance polyethersulfone (PES) substrates (support layer) with the bicontinuous structure can be prepared by using a solvent system including 2-pyrrolidone (2PD) and 2-methoxyethanol (2-ME) by vapor-induced phase separation, followed by immersion in a nonsolvent, water.

Also provided are methods of making a membrane selective layer by synthesizing a sterically-hindered polyamine (SH-PVAm) with a N-methylation degree of 20% from 50% (e.g., from 30% to 50%, such as about 39%), and combining the sterically-hindered polyamine with a low molecular weight amino compound such as with PEZA-Sar (e.g., 85 wt. % PEZA-Sar).

In certain embodiments, sterically-hindered polyamine (SH-PVAm) can comprise from 5 to 50 mol % secondary amine-containing monomers, based on the total of all amine-containing monomers in the sterically-hindered polyamine (SH-PVAm).

In some embodiments, the sterically-hindered polyamine (SH-PVAm) can comprise from 45 to 90 mol % primary amine-containing monomers, based on the total of all amine-containing monomers in the sterically-hindered polyamine (SH-PVAm). In some embodiments, the sterically-hindered polyamine (SH-PVAm) can comprise less than 5 mol % tertiary amine-containing monomers, such as less than 1 mol % tertiary amine-containing monomers or less than 0.5 mol % tertiary amine-containing monomers, based on the total of all amine-containing monomers in the sterically-hindered polyamine (SH-PVAm).

In certain embodiments, the sterically-hindered polyamine (SH-PVAm) can comprise poly(N-methyl-N-vinylamine) or a copolymer or blend thereof. In certain embodiments, the sterically-hindered polyamine (SH-PVAm) comprises a random copolymer or block copolymer having the structure below

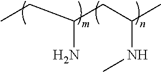

wherein m is an integer from 10 to 10,000; and n is an integer from 10 to 10,000.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 shows a schematic diagram of the pilot-scale continuous casting machine.

FIGS. 2A-2C show surface morphologies of: the PES substrate in Sample 1 (FIG. 2A), the optimized PES substrate prepared using NMP as the solvent in comparative reference 1 (FIG. 2B), and the PES substrate prepared using 2PD as the only solvent in comparative reference 2 (FIG. 2C).

FIGS. 3A-3B show cross-sectional morphologies of: the PES substrate in Sample 1 (FIG. 3A), and the optimized PES substrate prepared using NMP as the solvent in comparative reference 1 (FIG. 3B).

FIG. 4 shows surface morphology of the PES substrate in Example 2.

FIG. 5 shows surface morphology of the PES substrate in Example 3.

FIG. 6 shows surface morphology of the PES substrate in Example 4.

FIG. 7 shows surface morphology of the PES substrate in Example 5.

FIG. 8 shows a schematic of the gas transport measurement unit.

FIG. 9 shows a schematic diagram of hexafluoro-2-propanol and its strong hydrogen bonding ability with amine.

Like reference symbols in the various drawings indicate like elements.

### DETAILED DESCRIPTION

Because of the high CO₂/N₂ selectivity of at least 80 (e.g., from 80 to 800) at 57-97° C. and 1-6 bar feed pressure for carbon capture from flue gas, amine-containing polymeric membranes are a promising technology for efficient carbon dioxide capture.

A number of embodiments of the disclosure have been described. Nevertheless, it will be understood that various modifications may be made without departing from the spirit and scope of the invention. Accordingly, other embodiments are within the scope of the following claims. Disclosed herein are membranes and methods of making membranes which possess extraordinary CO₂/N₂ separation performances. The selective layer of the membrane can include, for example, sterically hindered polyvinylamine as the polymer matrix and small molecule amines as the mobile carrier to facilitate the transport of CO₂.

Accordingly, membranes, methods of making the membranes, and methods of using the membranes are described herein. The membranes can comprise a support layer, and a selective polymer layer disposed (e.g., coated) on the support layer.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs.

As used herein, “alkyl” means a straight or branched chain saturated hydrocarbon moieties such as those containing from 1 to 10 carbon atoms. A “higher alkyl” refers to saturated hydrocarbon having 11 or more carbon atoms. A “C₆-C₁₆” refers to an alkyl containing 6 to 16 carbon atoms. Likewise, a “C₆-C₂₂” refers to an alkyl containing 6 to 22 carbon atoms. Representative saturated straight chain alkyls include methyl, ethyl, n-propyl, n-butyl, n-pentyl, n-hexyl, n-heptyl, n-octyl, n-nonyl, and the like; while saturated branched alkyls include isopropyl, sec-butyl, isobutyl, tert-butyl, isopentyl, and the like.

As used herein, the term “alkenyl” refers to unsaturated, straight or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C.

As used herein, the term “alkynyl” represents straight or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, I-ethyl-3-butynyl, 2-ethyl-3-butynyl, and 1-ethyl-1-methyl-2-propynyl.

Non-aromatic mono or polycyclic alkyls are referred to herein as “carbocycles” or “carbocyclyl” groups. Representative saturated carbocycles include cyclopropyl, cyclobutyl, cyclopentyl, cyclohexyl, and the like, while unsaturated carbocycles include cyclopentenyl and cyclohexenyl, and the like.

“Heterocarbocycles” or “heterocarbocyclyl” groups are carbocycles which contain from 1 to 4 heteroatoms independently selected from nitrogen, oxygen and sulfur which can be saturated or unsaturated (but not aromatic), monocyclic or polycyclic, and wherein the nitrogen and sulfur heteroatoms can be optionally oxidized, and the nitrogen heteroatom can be optionally quaternized. Heterocarbocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

The term “aryl” refers to aromatic homocyclic (i.e., hydrocarbon) mono-, bi- or tricyclic ring-containing groups preferably having 6 to 12 members such as phenyl, naphthyl and biphenyl. Phenyl is a preferred aryl group. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and, the like, where optionally one or more pair of substituents together with the atoms to which they are bonded form a 3 to 7 member ring.

As used herein, “heteroaryl” or “heteroaromatic” refers an aromatic heterocarbocycle having 1 to 4 heteroatoms selected from nitrogen, oxygen and sulfur, and containing at least 1 carbon atom, including both mono- and polycyclic ring systems. Polycyclic ring systems can, but are not required to, contain one or more non-aromatic rings, as long as one of the rings is aromatic. Representative heteroaryls are furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl, and quinazolinyl. It is contemplated that the use of the term “heteroaryl” includes N-alkylated derivatives such as a 1-methylimidazol-5-yl substituent.

As used herein, “heterocycle” or “heterocyclyl” refers to mono- and polycyclic ring systems having 1 to 4 heteroatoms selected from nitrogen, oxygen and sulfur, and containing at least 1 carbon atom. The mono- and polycyclic ring systems can be aromatic, non-aromatic or mixtures of aromatic and non-aromatic rings. Heterocycle includes heterocarbocycles, heteroaryls, and the like.

“Alkylthio” refers to an alkyl group as defined above with the indicated number of carbon atoms attached through a sulfur bridge. An example of an alkylthio is methylthio, (i.e., —S—CH₃).

“Alkoxy” refers to an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. Preferred alkoxy groups are methoxy, ethoxy, n-propoxy, i-propoxy, n-butoxy, s-butoxy, t-butoxy.

“Alkylamino” refers an alkyl group as defined above with the indicated number of carbon atoms attached through an amino bridge. An example of an alkylamino is methylamino, (i.e., —NH—CH₃).

“Alkanoyl” refers to an alkyl as defined above with the indicated number of carbon atoms attached through a carbonyl bride (i.e., —(C═O)alkyl).

“Alkylsulfonyl” refers to an alkyl as defined above with the indicated number of carbon atoms attached through a sulfonyl bridge (i.e., —S(═O)₂alkyl) such as mesyl and the like, and “Arylsulfonyl” refers to an aryl attached through a sulfonyl bridge (i.e., —S(═O)₂aryl).

“Alkylsulfamoyl” refers to an alkyl as defined above with the indicated number of carbon atoms attached through a sulfamoyl bridge (i.e., —NHS(═O)₂alkyl), and an “Arylsulfamoyl” refers to an alkyl attached through a sulfamoyl bridge (i.e., —NHS(═O)₂aryl).

“Alkylsulfinyl” refers to an alkyl as defined above with the indicated number of carbon atoms attached through a sulfinyl bridge (i.e. —S(═O)alkyl).

The terms “cycloalkyl” and “cycloalkenyl” refer to mono-, bi-, or tri homocyclic ring groups of 3 to 15 carbon atoms which are, respectively, fully saturated and partially unsaturated. The term “cycloalkenyl” includes bi- and tricyclic ring systems that are not aromatic as a whole, but contain aromatic portions (e.g., fluorene, tetrahydronapthalene, dihydroindene, and the like). The rings of multi-ring cycloalkyl groups can be either fused, bridged and/or joined through one or more spiro unions. The terms “substituted cycloalkyl” and “substituted cycloalkenyl” refer, respectively, to cycloalkyl and cycloalkenyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally substituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like.

The terms “halogen” and “halo” refer to fluorine, chlorine, bromine, and iodine.

The term “substituted” refers to a molecule wherein at least one hydrogen atom is replaced with a substituent. When substituted, one or more of the groups are “substituents.” The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

Reference will now be made in detail to specific aspects of the disclosed materials, compositions, articles, and methods, examples of which are illustrated in the accompanying Examples.

Membranes

Generally, a membrane for gas separation consists of a dense top layer responsible for the separation and a porous substrate layer (can also be referred to herein as a “support layer”) to provide the mechanical support. Although the major separation is achieved by the selective top layer, the pore structure of the substrate has a significant effect on the gas transport performance of the composite membrane.

Membranes, methods of making the membranes, and methods of using the membranes are described herein. The membranes can comprise a gas permeable support layer, and a selective polymer layer disposed (e.g., coated) on the gas permeable support layer. The gas permeable support layer and the selective polymer layer can optionally comprise one or more sub-layers.

Gas Permeable Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-iso-propylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In some embodiments, the support layer can further include a hydrophilic additive(s), a solvent(s), a pore forming agent(s), or a combination thereof. In some embodiment, the hydrophilic additive comprises polyvinylpyrrolidone, polyvinylalcohol, polyethylene glycol derivatives, polyethylene oxide, poly(methyl methacrylate), amphiphilic copolymers such as Pluronic® P-123 and Pluronic® F-127, surfactants such as sorbitan monooleate (Span-80), inorganic particles such as TiO₂, SiO₂, Al₂O₃, Fe₃O₄, ZrO₂, Mg(OH)₂, ZnO, hydrophilic-functionalized carbon nanotubes, graphene oxide, and zeolite.

In some embodiments, the solvent(s) can include 2-pyrrolidone, 2-methoxyethanol, N-methyl pyrrolidone (NMP), N,N-dimethyl formamide (DMF), N,N-dimethyl acetamide (DMAc), or a combination thereof.

In some embodiment, the pore forming agent(s) can include 2-methoxyethanol, alcohols, multi-alcohols, water, inorganic salts such as LiCl and ZnCl₂.

In some embodiment, the support layer has a bicontinuous structure. In certain embodiments, the support layer can include a gas permeable polymer disposed (e.g., casted) on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

In some embodiments, the support layer has a CO₂ permeance of at least 25,000 GPU at 57° C. and ambient pressure (1 atm). For example, the support layer has a CO₂ permeance of from 25,000 GPU to 150,000 GPU, from 30,000 GPU to 150,000 GPU, or from 50,000 GPU to 100,000 GPU at 57° C. and ambient pressure.

Selective Polymer Layer

The selective polymer layer can include a selective polymer matrix and optionally, graphene oxide dispersed within the selective polymer matrix. The selective polymer matrix can include a hydrophilic polymer, an amino compound (e.g., an amine-containing polymer, a low molecular weight amino compound, or a combination thereof), a cross-linking agent, a CO₂-philic ether, or a combination thereof.

In other embodiments, the selective polymer matrix can include a combination of a hydrophilic polymer, cross-linking agent, and an amino compound. For example, in some cases, the selective polymer matrix can include an amino compound (e g, a small molecule, a polymer, or a combination thereof) dispersed in a hydrophilic polymer matrix.

In some embodiments, selective polymer matrix can include a hydrophilic polymer, an amino compound (e.g., an amine-containing polymer, a low molecular weight amino compound, or a combination thereof), and a cross-linking agent. In some embodiments, selective polymer matrix can include a hydrophilic polymer, a crosslinking agent, and an amino compound (e.g., an amine-containing polymer, a low molecular weight amino compound, or a combination thereof).

The selective polymer matrix can include a crosslinked hydrophilic polymer, an amino compound (e.g., an amine-containing polymer, a low molecular weight amino compound, or a combination thereof). In some embodiments, selective polymer matrix can include a crosslinked hydrophilic polymer and an amino compound (e.g., an amine-containing polymer, a low molecular weight amino compound, or a combination thereof).

In some embodiments, selective polymer matrix can include an amine-containing polymer (e.g., polyvinylamine), a hydrophilic polymer (e.g., polyvinyl alcohol (PVA)), a cross-linking agent (e.g., aminosilane), and a low molecular weight amino compound (e.g., PZEA-Sar, PZEA-ALBA, or a combination thereof). In some embodiments, selective polymer matrix can include an amine-containing polymer (e.g., polyvinylamine), a hydrophilic polymer (e.g., polyvinyl alcohol), a cross-linking agent (e.g., aminosilane), a low molecular weight amino compound (e.g., PZEA-Sar, PZEA-AIBA, HEP, or a combination thereof), and a CO₂-philic ether (e.g., poly(ethylene glycol) dimethyl ether). In some embodiments, selective polymer matrix can include an amine-containing polymer (e.g., polyvinylamine), a hydrophilic polymer (e.g., polyvinyl alcohol), and a cross-linking agent (e.g., aminosilane). In some embodiments, selective polymer matrix can include an amine-containing polymer (e.g., polyvinylamine), a hydrophilic polymer (e.g., polyvinyl alcohol), a cross-linking agent (e.g., aminosilane), and a CO₂-philic ether (e.g., poly(ethylene glycol) dimethyl ether).

In some embodiments, selective polymer matrix can include a hydrophilic polymer (e.g., polyvinyl alcohol), a cross-linking agent (e.g., aminosilane), and a low molecular weight amino compound (e.g., PZEA-Sar, PZEA-AIBA, HEP, or a combination thereof). In some embodiments, selective polymer matrix can include a hydrophilic polymer (e.g., polyvinyl alcohol), a cross-linking agent (e.g., aminosilane), a low molecular weight amino compound (e.g., PZEA-Sar, PZEA-AIBA, HEP, or a combination thereof), and a CO₂-philic ether (e.g., poly(ethylene glycol) dimethyl ether).

In some embodiments, selective polymer matrix can include an amine-containing polymer (e.g., polyvinylamine), a crosslinked hydrophilic polymer (e.g., aminosilane crosslinked polyvinyl alcohol), and a low molecular weight amino compound (e.g., PZEA-Sar, PZEA-AIBA, HEP, or a combination thereof). In some embodiments, selective polymer matrix can include an amine-containing polymer (e.g., polyvinylamine), a crosslinked hydrophilic polymer (e.g., aminosilane crosslinked polyvinyl alcohol), a low molecular weight amino compound (e.g., PZEA-Sar, PZEA-AIBA, HEP, or a combination thereof), and a CO₂-philic ether (e.g., poly(ethylene glycol) dimethyl ether). In some embodiments, selective polymer matrix can include an amine-containing polymer (e.g., polyvinylamine), a crosslinked hydrophilic polymer (e.g., aminosilane crosslinked polyvinyl alcohol), and a CO₂-philic ether (e.g., poly(ethylene glycol) dimethyl ether). In some embodiments, selective polymer matrix can include an amine-containing polymer (e.g., polyvinylamine), and a crosslinked hydrophilic polymer (e.g., aminosilane crosslinked polyvinyl alcohol).

In some embodiments, selective polymer matrix can include a crosslinked hydrophilic polymer (e.g., aminosilane crosslinked polyvinyl alcohol), and a low molecular weight amino compound (e.g., PZEA-Sar, PZEA-AIBA, HEP, or a combination thereof). In some embodiments, selective polymer matrix can include a crosslinked hydrophilic polymer (e.g., aminosilane crosslinked polyvinyl alcohol), a low molecular weight amino compound (e.g., PZEA-Sar, PZEA-AIBA, HEP, or a combination thereof), and a CO₂-philic ether (e.g., poly(ethylene glycol) dimethyl ether).

In some cases, the selective polymer layer can be a selective polymer matrix through which gas permeates via diffusion or facilitated diffusion. The selective polymer layer can comprise a selective polymer matrix having a CO₂:N₂ selectivity of at least 10 at 57° C. and 1 bar feed pressure. For example, the selective polymer matrix can have a CO₂:N₂ selectivity of at least 25 (e.g., at least 50, at least 75, at least 100, at least 125, at least 150, at least 175, at least 200, at least 225, at least 250, at least 275, at least 300, at least 325, at least 350, at least 375, at least 400, at least 425, at least 450, or at least 475) at 57° C. and 1 bar feed pressure. In some embodiments, the selective polymer matrix can have a CO₂:N₂ selectivity of 500 or less (e.g., 475 or less, 450 or less, 425 or less, 400 or less, 375 or less, 350 or less, 325 or less, 300 or less, 275 or less, 250 or less, 225 or less, 200 or less, 175 or less, 150 or less, 125 or less, 100 or less, 75 or less, 50 or less, or 25 or less) at 57° C. and 1 bar feed pressure.

In certain embodiments, the selective polymer layer can include a selective polymer matrix that has a CO₂:N₂ selectivity ranging from any of the minimum values described above to any of the maximum values described above. For example, in certain embodiments, the selective polymer layer can comprise a selective polymer matrix that has a CO₂:N₂ selectivity of from 10 to 500 at 57° C. and 1 bar feed pressure (e.g., from 10 to 400 at 57° C. and 1 bar feed pressure, from 75 to 400 at 57° C. and 1 bar feed pressure, from 100 to 400 at 57° C. and 1 bar feed pressure, from 10 to 350 at 57° C. and 1 bar feed pressure, from 75 to 350 at 57° C. and 1 bar feed pressure, from 100 to 350 at 57° C. and 1 bar feed pressure, from 10 to 250 at 57° C. and 1 bar feed pressure, from 75 to 250 at 57° C. and 1 bar feed pressure, or from 100 to 250 at 57° C. and 1 bar feed pressure). The CO₂:N₂ selectivity of the selective polymer can be measured using standard methods for measuring gas permeance known in the art, such as those described in the examples below.

In some embodiments, the selective polymer layer can comprise a selective polymer matrix having a CO₂/N₂ selectivity of at least 80 at 57-97° C. and 1-6 bar feed pressure. In some cases, the selective polymer matrix has a CO₂/N₂ selectivity of 80-800 at 57-97° C. and 1-6 bar feed pressure.

Cross-Linking Agents

The selective polymer matrix can include a cross-linking agent. Cross-linking agents suitable for use in the selective polymer matrix can include, but are not limited to, aminosilane, formaldehyde, glutaraldehyde, maleic anhydride, glyoxal, divinylsulfone, toluenediisocyanate, trimethylol melamine, terephthalatealdehyde, epichlorohydrin, or vinyl acrylate, and combinations thereof. In some embodiments, the cross-linking agent can include aminosilane. In some embodiments, the cross-linking agent can include aminosilane and glyoxal. The selective polymer matrix can include any suitable amount of the cross-linking agent. For example, the selective polymer matrix can comprise 1 to 70 percent cross-linking agents by weight of the selective polymer matrix. In some embodiments, the cross-linking agent can be at least 30%, at least 35%, at least 40% or at least 50%. In some embodiments, the cross-linking agent can be 40% aminosilane and 20% glyoxal by weight of the selective polymer matrix. In some embodiments, the cross-linking agent can be 35% aminosilane and 25% glyoxal by weight of the selective polymer matrix.

In some cases, the cross-linking agent can be an aminosilane defined by Formula I below

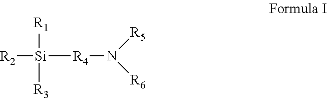

wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;

wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;

wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; Ra is selected from substituted or unsubstituted alkyl; and R₅ and R₆ are each independently selected from hydrogen, or substituted or unsubstituted alkyl;

wherein at least one R₁, R₂ or R₃ is a substituted or unsubstituted alkoxy.

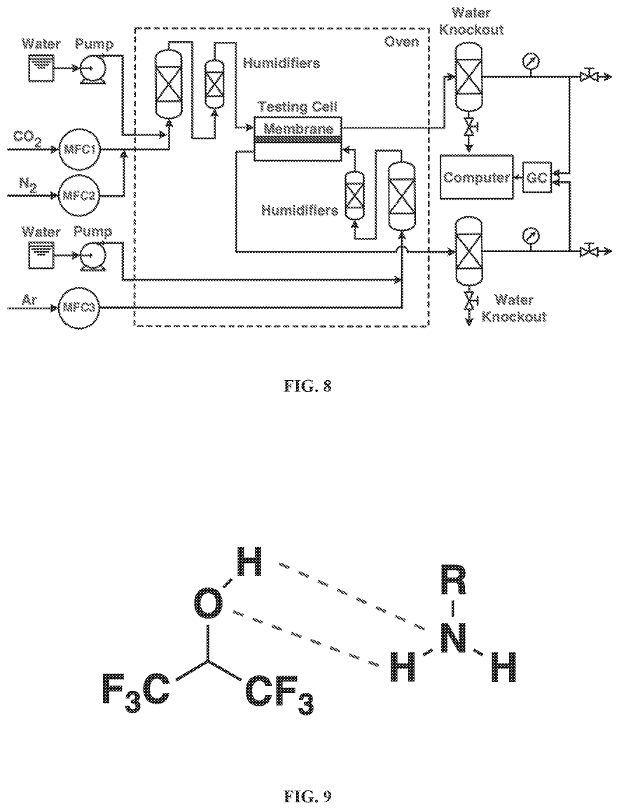

In some cases, the cross-linking agent can be 3-aminopropyltriethoxysilane, N-[3-(trimethoxysilyl)propyl]ethylenediamine, (N,N-dimethylaminopropyl)timethoxysilane, (N,N-dimenthylaminopropyl) dimethoxymethylsilane, (N,N-dimethylaminopropyl) dimethylmethoxysilane, (N,N-diethylaminopropyl) dimethoxymethylsilane, (N,N-diisopropylaminopropyl) dimethoxysilane, (N,N-diisopropylaminopropyl) trimethoxysilane, or blends thereof (FIG. 8).

Hydrophilic Polymers

The selective polymer matrix can include any suitable hydrophilic polymer. In some embodiments, the hydrophilic polymer is crosslinked with an aminosilane defined by Formula I. Examples of hydrophilic polymers suitable for use in the selective polymer layer can include polyvinylalcohol, polyvinylacetate, polyethylene oxide, polyvinylpyrrolidone, polyacrylamine, a polyamine such as polyallylamine, polyvinyl amine, or polyethylenimine, copolymers thereof, and blends thereof. In some embodiments, the hydrophilic polymer includes polyvinylalcohol.

The selective polymer matrix can include any suitable crosslinked hydrophilic polymer (e.g., aminosilane crosslinked polyvinyl alcohol). Examples of crosslinked hydrophilic polymers suitable for use in the selective polymer layer can include 3-aminopropyltriethoxysilane crosslinked polyvinyl alcohol, N-[3-(trimethoxysilyl)propyl]ethylenediamine crosslinked polyvinyl alcohol, (N,N-dimethylaminopropyl)timethoxysilane crosslinked polyvinyl alcohol, (N,N-dimenthylaminopropyl)dimethoxymethylsilane crosslinked polyvinyl alcohol, (N,N-dimethylaminopropyl)dimethylmethoxysilane crosslinked polyvinyl alcohol, (N,N-diethylaminopropyl)dimethoxymethylsilane crosslinked polyvinyl alcohol, (N,N-diisopropylaminopropyl)dimethoxysilane crosslinked polyvinyl lalcohol, (N,N-diisopropylaminopropyl)trimethoxysilane crosslinked polyvinyl alcohol, or copolymers thereof, and blends thereof.

When present, the hydrophilic polymer can have any suitable molecular weight. For example, the hydrophilic polymer can have a weight average molecular weight of from 15,000 Da to 2,000,000 Da (e.g., from 50,000 Da to 1,100,000 Da, or from 50,000 Da to 200,000 Da). In some embodiments, the hydrophilic polymer can include polyvinyl alcohol having a weight average molecular weight of from 50,000 Da to 1,100,000 Da (e.g., or from 50,000 Da to 150,000 Da). In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can include any suitable amount of the hydrophilic polymer. For example, in some cases, the selective polymer layer can include from 10% to 90% by weight (e.g., from 10% to 50% by weight, or from 10% to 30% by weight) hydrophilic polymer, based on the total weight of the components used to form the selective polymer layer.

When present, the crosslinked hydrophilic polymer can have any suitable molecular weight. For example, the crosslinked hydrophilic polymer can have a weight average molecular weight of from 15,000 Da to 2,000,000 Da (e.g., from 50,000 Da to 1,500,000 Da, or from 50,000 Da to 200,000 Da). In some embodiments, the crosslinked hydrophilic polymer can include aminosilane crosslinked polyvinyl alcohol having a weight average molecular weight of from 50,000 Da to 1,500,000 Da (e.g., or from 50,000 Da to 150,000 Da) In other embodiments, the crosslinked hydrophilic polymer can be a high molecular weight crosslinked hydrophilic polymer. For example, the crosslinked hydrophilic polymer can have a weight average molecular weight of at least 500,000 Da (e.g., at least 700,000 Da, or at least 1,000,000 Da).

The selective polymer layer can include any suitable amount of the crosslinked hydrophilic polymer. For example, in some cases, the selective polymer layer can include from 10% to 90% by weight (e.g., from 10% to 50% by weight, or from 10% to 30% by weight) crosslinked hydrophilic polymer, based on the total weight of the components used to form the selective polymer layer.

Amino Compounds

In some embodiments, the amino compound can include a compound (e.g., a small molecule, a polymer, or a combination thereof) comprising one or more primary amine moieties and/or one or more secondary amine moieties. The amino compound can be, for example, an amine-containing polymer, a low molecular weight amino compound (i.e., a small molecule), or a combination thereof. In some embodiments, the selective polymer layer can comprise an amine-containing polymer and an amino acid salt. In these embodiments, the amine-containing polymer can serve as a “fixed-site carrier” and the amino acid salt can serve as a “mobile carrier.”

In some embodiments, the amino compound comprises an amine-containing polymer (also referred to herein as a “fixed-site carrier”). The amine-containing polymer can have any suitable molecular weight. For example, the amine-containing polymer can have a weight average molecular weight of from 5,000 Da to 5,000,000 Da, or from 50,000 Da to 2,000,000 Da. The amine-containing polymer can be a high molecular weight amine-containing polymer. For example, the amine-containing polymer can have a weight average molecular weight of at least 500,000 Da (e.g., at least 700,000 Da, or at least 1,000,000 Da). In certain embodiments, the amine-containing polymer can have a weight average molecular weight of from 500,000 Da to 5,000,000 Da, or from 500,000 Da to 2,000,000 Da. The amine-containing polymer can also be a modest molecular weight amine-containing polymer. For example, the amine-containing polymer can have a weight average molecular weight of at least 50,000 Da (e.g., at least 100,000 Da, or at least 500,000 Da). In certain embodiments, the amine-containing polymer can have a weight average molecular weight of from 50,000 Da to 500,000 Da.

Suitable examples of amine-containing polymers include, but are not limited to, polyvinylamine, polyallylamine, polyethyleneimine, poly-N-isopropylallylamine, poly-N-tert-butylallylamine, poly-N-1,2-dimethylpropylallylamine, poly-N-1-methylpropylallylamine, poly-N-2-methylpropylallylamine, poly-N-1-ethylpropylallylamine, poly-N-2-ethylpropylallylamine, poly-N-methylallylamine, poly-N,N-dimethylallylamine, poly-N-ethylallylamine, poly-N,N-diethylallylamine, poly(N-methyl-N-vinylamine), poly(N-ethyl-N-vinylamine), poly(N-isopropyl-N-vinylamine), poly(N-tert-butyl-N-vinylamine), poly(N-propyl-N-vinylamine), poly(N,N-dimethyl-N-vinylamine), poly(N,N-diethyl-N-vinylamine), poly-2-vinylpiperidine, poly-4-vinylpiperidine, polyaminostyrene, chitosan, copolymers, and blends thereof.

In some embodiments, the amine-containing polymer can comprise polyvinylamine or a sterically hindered derivative of polyvinylamine (e.g., polyvinylamine having a weight average molecular weight of from 50,000 Da to 2,000,000 Da). For example, the amine-containing polymer can be polyvinylamine or a sterically hindered derivative of polyvinylamine having a weight average molecular weight of from 500,000 Da to 5,000,000 Da, or from 500,000 Da to 2,000,000 Da. In particular embodiments, the amine-containing polymer can be polyvinylamine or a sterically hindered derivative of polyvinylamine having a weight average molecular weight of at least 500,000 Da (e.g., at least 700,000 Da, or at least 1,000,000 Da).

In some embodiments when the amino compound includes an amine-containing polymer, the selective polymer layer can include a blend of an amine-containing polymer and a hydrophilic polymer (e.g., an amine-containing polymer dispersed in a hydrophilic polymer matrix).

In some embodiments, the amino compound can comprise a low molecular weight amino compound (also referred to herein as a “mobile carrier”). The low molecular weight amino compound can have a molecular weight of 1,000 Da or less (e.g., 800 Da or less, 500 or less, 300 Da or less, or 250 Da or less). In some embodiments, the low molecular weight amino compound can be non-volatile at the temperatures at which the membrane will be stored or used. For example, the low molecular weight amino compound can comprise a salt of a primary amine or a salt of a secondary amine. In some embodiments when the amino compound comprises a low molecular weight amino compound, the selective polymer layer can comprise a blend of the low molecular weight amino compound and a hydrophilic polymer (e.g., a low molecular weight amino compound dispersed in a hydrophilic polymer matrix).

In some embodiments, the selective polymer layer can comprise an amine-containing polymer and an amino acid salt dispersed within the amine-containing polymer. In these embodiments, the amine-containing polymer can serve as a “fixed-site carrier” and the amino acid salt can serve as a “mobile carrier.”

In some cases, the amine-containing polymer can include polyvinylamine. In some cases, the amine-containing polymer can include a sterically hindered derivative of polyvinylamine. In some embodiments, the sterically hindered derivative of polyvinylamine includes a monomer having the structure below

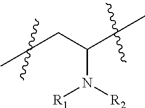

wherein R₁ and R₂ are, independently for each occurrence, hydrogen, alkyl, alkenyl, alkynyl, aryl, or cycloalkyl, or R₁ and R₂, together with the nitrogen atom to which they are attached, form a hetercyclic ring, with the proviso that at least one of R₁ and R₂ is not hydrogen.

In some cases, the amine-containing polymer can include polyvinylamine. In some cases, the amine-containing polymer can include a sterically hindered derivative of polyvinylamine. In some embodiments, the sterically hindered derivative of polyvinylamine includes a polymer having the structure below

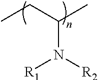

wherein R₁ and R₂ are, independently for each occurrence, hydrogen, alkyl, alkenyl, alkynyl, aryl, or cycloalkyl, or R₁ and R₂, together with the nitrogen atom to which they are attached, form a hetercyclic ring, with the proviso that at least one of R₁ and R₂ is not hydrogen; and n is an integer from 10 to 25,000. In some embodiments, the sterically hindered derivative of polyvinylamine comprises a random copolymer or block copolymer having the structure below

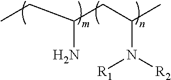

wherein R₁ and R₂ are, independently for each occurrence, hydrogen, alkyl, alkenyl, alkynyl, aryl, or cycloalkyl, or R₁ and R₂, together with the nitrogen atom to which they are attached, form a hetercyclic ring, with the proviso that at least one of R₁ and R₂ is not hydrogen; m is an integer from 10 to 10,000; and n is an integer from 10 to 10,000.

In some embodiments, the sterically hindered amine-containing polymer comprises from 5 wt % to 50 wt % secondary amine monomers out of all the amine containing monomers in the amine-containing polymer. For example, from 10 wt % to 50 wt %, from 20 wt % to 50 wt %, or from 30 wt % to 50 wt %. In some embodiments, the sterically hindered amine-containing polymer comprises from 45 wt % to 90 wt % primary amine monomers out of all the amine containing monomers in the amine-containing polymer. For example, from 55 wt % to 90 wt %, from 60 wt % to 90 wt %, or 75 wt % to 90 wt %. In some embodiments, the sterically hindered amine-containing polymer comprises less than 5 wt % tertiary amine monomers out of all the amine containing monomers in the amine-containing polymer. For example, less than 0.1 wt %, less than 0.5 wt %, less than 1 wt %, or less than 2 wt %.

In some embodiments, the sterically hindered derivative of polyamine is poly(N-methyl-N-vinylamine). In some embodiments, the N-methylation degree of the sterically hindered derivative of polyamine is at least 5 wt %. The N-methylation degree can range from 5 wt % to 45 wt %, from 30 wt % to 40 wt %, or from 20 wt % to 40 wt %. In some preferred embodiments, the N-methylation degree of the sterically hindered derivative of polyamine is 39 wt %.

In some cases, the low molecular weight amino compound can include an amino acid salt. The amino acid salt can be a salt of any suitable amino acid. The amino acid salt may be derived, for instance, from glycine, arginine, lysine, histidine, 6-aminohexanoic acid, proline, sarcosine, methionine, or taurine. In some cases, the amino acid salt can comprise a salt of a compound defined by the formula below

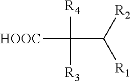

wherein, independently for each occurrence in the amino acid, each of R₁, R₂, R₃ and R₄ is selected from one of the following

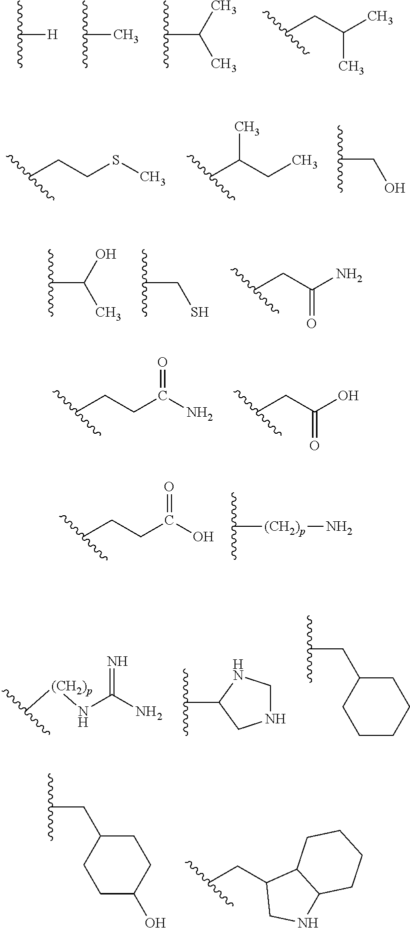

wherein

at least one of R₁-R₄ comprises an amino group and p, when present, is an integer from 1 to 4,

or R₁ and R₃, together with the atoms to which they are attached, form a five-membered heterocycle defined by the structure below when n is 1, or a six-membered heterocycle defined by the structure below when n is 2,

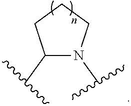

Poly(amino-acids), for example, polyarginine, polylysine, polyonithine, or polyhistidine may also be used to prepare the amino acid salt.

In other embodiments, the low molecular weight amino compound can be defined by a formula below

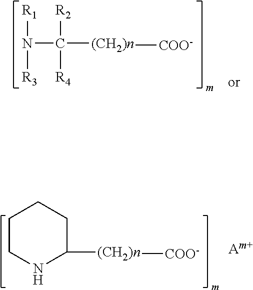

wherein R₁, R₂, R₃, and R₄ are hydrogen or hydrocarbon groups having from 1 to 4 carbon atoms, n is an integer ranging from 0 to 4, A^{m+} is a cation having a valence of 1 to 3. In some cases, the cation (A^{m+}) can be an amine cation having the formula:

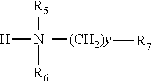

wherein R₅ and R₆ are hydrogen or hydrocarbon groups having from 1 to 4 carbon atoms, R₇ is hydrogen or hydrocarbon groups having from 1 to 4 carbon atoms or an alkyl amine of from 2 to 6 carbon atoms and 1 to 4 nitrogen atoms, y is an integer ranging from 1 to 4, and m is an integer equal to the valence of the cation. In some embodiments, A^{m+} is a metal cation selected from Groups Ia, IIa, and IIIa of the Periodic Table of Elements or a transition metal. For example, A^{m+} can comprise lithium, aluminum, or iron.

Other suitable low molecular weight amino compounds include aminoisobutyric acid-potassium salt, aminoisobutyric acid-lithium salt, aminoisobutyric acid-piperazine salt, glycine-potassium salt, glycine-lithium salt, glycine-piperazine salt, dimethylglycine-potassium salt, dimethylglycine-lithium salt, dimethylglycine-piperazine salt, piperadine-2-carboxlic acid-potassium salt, piperadine-2-carboxlic acid-lithium salt, piperadine-2-carboxlic acid-piperazine salt, piperadine-4-carboxlic acid-potassium salt, piperadine-4-carboxlic acid-lithium salt, piperadine-4-carboxlic acid-piperazine salt, piperadine-3-carboxlic acid-potassium salt, piperadine-3-carboxlic acid-lithium salt, piperadine-3-carboxlic acid-piperazine salt, and blends thereof.

In some embodiments, the amino acid salt is 2-(1-piperazinyl)ethylamine sarcosinate. In some embodiments, the membrane includes at least 60 wt % amino acid salt. For example, the membrane includes from 60 wt % to 90 wt %, from 70 wt % to 90 wt %, from 70 wt % to 95 wt % amino acid salt. In some preferred embodiments, the membrane includes 85 wt % amino acid salt.

CO₂-Philic Ethers

The selective polymeric matrix can further include a one or more CO₂-philic ethers. The CO₂-philic ether can be a polymer, oligomer, or small molecule containing one or more ether linkages. Examples of CO₂-philic ethers include alcohol ethers, polyalkylene alcohol ethers, polyalkylene glycols, poly(oxyalkylene)glycols, poly(oxyalkylene)glycol ethers, ethoxylated phenol. In one embodiment, the CO₂-philic ether can comprise alkyl ethoxylate (C1-C6)-XEO X=1-30-linear or branched. In some embodiments, the CO₂-philic ether can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), polyethylene glycol dimethyl ether (PEGDME), or any combination thereof.

Graphene Oxide

The selective polymer layer can further include graphene oxide.

The term “graphene” refers to a one-atom-thick planar sheet of sp2-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g. approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g. “GO(2)” refers to graphene oxide with a C:O ratio of 2.

In some embodiments, the graphene oxide can be GO((m). In some embodiments, the graphene oxide can be GO(L). In some embodiments, the graphene oxide can be nanoporous.

Other Components

The selective polymer matrix can further include a base. The base can act as a catalyst to catalyze the cross-linking of the selective polymer matrix (e.g, cross-linking of a hydrophilic polymer with an amine-containing polymer). In some embodiments, the base can remain in the selective polymer matrix and constitute a part of the selective polymer matrix. Examples of suitable bases include potassium hydroxide, sodium hydroxide, lithium hydroxide, triethylamine, N,N-dimnethylaminopyridine, hexamethyltriethylenetetraamine, potassium carbonate, sodium carbonate, lithium carbonate, and combinations thereof. In some embodiments, the base can include potassium hydroxide. The selective polymer matrix can comprise any suitable amount of the base. For example, the selective polymer matrix can comprise 1 to 40 percent base by weight of the selective polymer matrix.

The selective polymer layer further comprises carbon nanotubes dispersed within the selective polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of a least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then coupled to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer layer can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer layer. In some embodiments, the selective polymer layer can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer layer.

The selective polymer layer can comprise an amount of carbon nanotubes ranging from any of the minimum values described above to any of the maximum values described above. For example, the selective polymer layer can comprise from 0.5% to 5% (e.g., from 1% to 3%) by weight carbon nanotubes, based on the total dry weight of the selective polymer layer.

If desired, the selective polymer layer can be surface modified by, for example, chemical grafting, blending, or coating to improve the performance of the selective polymer layer. For example, hydrophobic components may be added to the selective polymer layer to alter the properties of the selective polymer layer in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 25 microns (e.g., from 100 nanometers to 750 nanometers, from 250 nanometers to 500 nanometers, from 50 nm to 2 microns, from 50 nm to 20 microns, or from 1 micron to 20 microns). In some embodiments, the support layer can have a thickness of from 1 micron to 500 microns (e.g., from 50 to 250 microns). In some cases, the membranes disclosed herein can have a thickness of from 5 microns to 500 microns. In some embodiments when used for hydrogen purification from syngas, the selective polymer layer can have a thickness of from 5 microns to 25 microns (e.g., from 10 microns to 20 microns, or about 15 microns). In some embodiments when used for carbon capture from flue gas, the selective polymer layer can have a thickness of from 50 nanometers to 500 nanometers (e.g., from 100 nanometers to 250 nanometers, or about 170 nanometers).

Methods of Making

Methods of making these membranes are also disclosed herein. Methods of making membranes can include depositing (e.g., coating) a selective polymer layer on a support layer to form a selective layer disposed (e.g., coated) on the support layer. The selective polymer layer can include a selective polymer matrix and optionally a graphene oxide dispersed within the selective polymer matrix. The support layer can include a gas permeable polymer, hydrophilic additive, solvent, and pore forming agent.

Optionally, the support layer can be pretreated prior to deposition (e.g., coating) of the selective polymer layer, for example, to remove water or other adsorbed species using methods appropriate to the support and the adsorbate. Examples of absorbed species are, for example, water, alcohols, porogens, and surfactant templates.

The support layer can be prepared by using a solvent system including 2-pyrrolidone (2PD) and 2-methoxyethanol (2-ME) by vapor-induced phase separation, followed by immersion in a nonsolvent, water. Vapor-induced phase separation (VIPS) is a typical technique to prepare substrates with bicontinuous structure. VIPS was used in U.S. Pat. No. 6,146,747 for the preparation of highly porous polyvinylidene difluoride membranes by utilizing the common solvents, e.g., N-methyl-2-pyrrolidone (NMP). VIPS was also used for the fabrication of polysulfone membranes with bicontinuous structures with 2-pyrrolidone (2PD) as the solvent by Tsai et al., J. Membr. Sci., 362 (2010) 360-373. However, to the best of our knowledge, there is no report about the preparation of PES membranes with bicontinuous structure using the solvent system comprising 2PD and 2-methoxyethanol (2-ME), nor any report on using such kind of PES as the substrates for preparing composite membranes.

The selective polymer layer can be prepared by first forming a coating solution including the components of the selective polymer matrix (e.g., a hydrophilic polymer, a cross-linking agent, an amino compound, a CO₂-philic ether, or a combination thereof; and optionally a basic compound and/or graphene oxide in a suitable solvent). One example of a suitable solvent is water. In some embodiments, the amount of water employed will be in the range of from 50% to 99%, by weight of the coating solution. The coating solution can then be used in forming the selective polymer layer. For example, the coating solution can be coated onto a support later (e.g., a nanoporous gas permeable membrane) using any suitable technique, and the solvent may be evaporated such that a nonporous membrane is formed on the substrate.

In some embodiments, the selective polymer matrix includes an amino compound such as amine-containing polymer and an amino salt. In some embodiments, the amine-containing polymer is a sterically hindered derivative of polyamine.

In some embodiments, when the sterically hindered derivative of polyamine is poly(N-methyl-N-vinylamine) the concentration of a polyamine used to make the sterically-hindered polyamine can range from 0.5 wt. % to 5 wt. %. In some preferred embodiments, the concentration is 2 wt. %.

In some embodiments, when the sterically hindered derivative of polyamine is poly(N-methyl-N-vinylamine) the methylation agent used to make the poly(N-methyl-N-vinylamine) can be formaldehyde or paraformaldehyde. In some preferred embodiments the methylation agent is paraformaldehyde.

In some embodiments, when the sterically hindered derivative of polyamine is poly(N-methyl-N-vinylamine) the solvent used to make the poly(N-methyl-N-vinylamine) can be hexafluoro-2-propanol (HFIP), trifluoroethanol (TFE), HFIP/MeOH, or HFIP/water. In some preferred embodiments the solvent is HFIP.

Examples of suitable coating techniques include, but are not limited to, “knife coating” or “dip coating”. Knife coating include a process in which a knife is used to draw a polymer solution across a flat substrate to form a thin film of a polymer solution of uniform thickness after which the solvent of the polymer solution is evaporated, at ambient temperatures or temperatures up to about 100° C. or higher, to yield a fabricated membrane. Dip coating include a process in which a polymer solution is contacted with a porous support. Excess solution is permitted to drain from the support, and the solvent of the polymer solution is evaporated at ambient or elevated temperatures. The membranes disclosed can be shaped in the form of hollow fibers, tubes, films, sheets, etc. In certain embodiments, the membrane can be configured in a flat sheet, a spiral-wound, a hollow fiber, or a plate-and-frame configuration.

In some embodiments, membranes formed from a selective polymer matrix containing for example, a hydrophilic polymer, a cross-linking agent, a base, an amino compound, a CO₂-philic ether, and/or graphene oxide can be heated at a temperature and for a time sufficient for cross-linking to occur. In one example, cross-linking temperatures in the range from 80° C. to 100° C. can be employed (e.g., from 80° C. to 90° C., from 90° C. to 100° C., or from 80° C. to 95° C.). In another example, cross-linking can occur from 1 to 72 hours (e.g., from 1 to 3 hours, from 1 to 6 hours, from 1 to 12 hours, from 1 to 24 hours, from 1 to 36 hours, from 1 to 48 hours, from 1 to 60 hours, from 12 to 24 hours, from 12 to 36 hours, from 12 to 48 hours, from 24 to 48 hours, from 24 to 60 hours, or from 12 to 72 hours). The resulting solution can be coated onto the support layer and the solvent evaporated, as discussed above. In some embodiments, a higher degree of cross-linking for the selective polymer matrix after solvent removal takes place at about 100° C. to about 180° C., and the cross-linking occurs in from about 1 to about 72 hours.

An additive may be included in the selective polymer layer before forming the selective polymer layer to increase the water retention ability of the membrane. Suitable additives include, but are not limited to, polystyrenesulfonic acid-potassium salt, polystyrenesulfonic acid-sodium salt, polystyrenesulfonic acid-lithium salt, sulfonated polyphenyleneoxides, alum, and combinations thereof. In one example, the additive comprises polystyrenesulfonic acid-potassium salt.

In some embodiments, the method of making these membranes can be scaled to industrial levels.

Methods of Use

The membranes disclosed herein can be used for separating gaseous mixtures. For example, provided are methods for separating a first gas from a feed gas comprising the first gas and one or more additional gases (e.g., at least a second gas). The method can include contacting any of the disclosed membranes (e.g., on the side comprising the selective polymer) with the feed gas under conditions effective to afford transmembrane permeation of the first gas. In some embodiments, the method can also include withdrawing from the reverse side of the membrane a permeate containing at least the first gas, wherein the first gas is selectively removed from the gaseous stream. The permeate can comprise at least the first gas in an increased concentration relative to the feed stream. The term “permeate” refers to a portion of the feed stream which is withdrawn at the reverse or second side of the membrane, exclusive of other fluids such as a sweep gas or liquid which may be present at the second side of the membrane.

The membrane can be used to separate fluids at any suitable temperature, including temperatures of 57° C. or greater. For example, the membrane can be used at temperatures of from 57° C. to 87° C. (e.g., from 60° C. to 80° C., from 60° C. to 70° C., from 57° C. to 70′C, from 65° C. to 75° C., from 70° C. to 85° C., from 70° C. to 80° C., from 75° C. to 85° C., or from 65° C. to 87° C.). In some embodiments, a vacuum can be applied to the permeate face of the membrane to remove the first gas. In some embodiments, a sweep gas can be flowed across the permeate face of the membrane to remove the first gas. Any suitable sweep gas can be used. Examples of suitable sweep gases include, for example, air, steam, nitrogen, argon, helium, and combinations thereof.

The first gas can include an acid gas. For example, the first gas can be carbon dioxide, hydrogen sulfide, sulfur dioxide, sulfur trioxide, nitrogen oxide, or combinations thereof. In some embodiments, the membrane can be selective to carbon dioxide versus hydrogen, nitrogen, carbon monoxide, or combinations thereof. In some embodiments, the membrane can be selective to hydrogen sulfide versus hydrogen, nitrogen, carbon monoxide, or combinations thereof. In some embodiments, the acid gas may be derived from fossil fuels that require hydrogen purification for fuel cell, electricity generation, and hydrogenation applications, biogas for renewable energy, and natural gas for commercial uses. For example, the membranes may be employed in a fuel cell (e.g., to purify feed gases prior to entering the fuel cell). The membranes can also be used for removal of carbon dioxide from flue gas.

The permeance of the first gas or the acid gas can be at least 50 GPU (e.g., 75 GPU or greater, 100 GPU or greater, 150 GPU or greater, 200 GPU or greater, 250 GPU or greater, 300 GPU or greater, 350 GPU or greater, 400 GPU or greater, 450 GPU or greater, 500 GPU or greater, 550 GPU or greater, 600 GPU or greater, 650 GPU or greater, 700 GPU or greater, 750 GPU or greater, 800 GPU or greater, 850 GPU or greater, 900 GPU or greater, 950 GPU or greater, 1000 GPU or greater, 1100 GPU or greater, 1200 GPU or greater, 1300 GPU or greater, or 1400 GPU or greater) at 57° C. and 1 bar feed pressure.

The permeance of the first gas or the acid gas can be 1500 GPU or less at 57° C. and 1 bar feed pressure (e.g., 1400 GPU or less, 1300 GPU or less, 1200 GPU or less, 1100 GPU or less, 1000 GPU or less, 950 GPU or less, 900 GPU or less, 850 GPU or less, 800 GPU or less, 750 GPU or less, 700 GPU or less, 650 GPU or less, 600 GPU or less, 550 GPU or less, 500 GPU or less, 450 GPU or less, 400 GPU or less, 350 GPU or less, 300 GPU or less, 250 GPU or less, 200 GPU or less, 150 GPU or less, 100 GPU or less, or 75 GPU or less).

The permeance of the first gas or the acid gas through the membrane can vary from any of the minimum values described above to any of the maximum values described above. For example, the permeance of the first gas or the acid gas can be from 50 GPU to 1500 GPU at 57° C. and 1 bar feed pressure (e.g., from 200 GPU to 1500 GPU, from 200 GPU to 1000 GPU, from 300 GPU to 1500 GPU at 57° C., from 300 GPU to 500 GPU, or from 500 GPU to 1500 GPU at 57° C. and 1 bar feed pressure).

The membrane can exhibit a first gas/second gas selectivity of at least 10 at 57° C. and 1 bar feed pressure. In some embodiments, the membrane can exhibit a first gas/second gas selectivity of up to 500 at 57° C. and 1 bar feed pressure. For example, the membrane can exhibit a first gas/second gas selectivity of 10 or greater, 25 or greater, 50 or greater, 75 or greater, 100 or greater, 125 or greater, 150 or greater, 175 or greater, 200 or greater, 225 or greater, 250 or greater, 275 or greater, 300 or greater, 325 or greater, 350 or greater, 375 or greater, 400 or greater, 425 or greater, 450 or greater, or 475 or greater at 57° C. and 1 bar feed pressure. In some embodiments, the permeance and selectivity of the membrane for the first gas or the acid gas can vary at higher or lower temperatures.

For the purposes of this specification and appended claims, unless otherwise indicated, all numbers expressing quantities, percentages or proportions, and other numerical values used in the specification and claims are to be understood as being modified in all instances by the term “about”. Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a”, “an”, and “the”, include plural references unless expressly and unequivocally limited to one referent.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

As used herein, terminology such as A, B, C, or any combination thereof (or the like such as A, B, C, or any mixtures thereof) relate to various options. In one embodiment, the terminology A, B, C, or any combination thereof means A only. In one embodiment, the terminology A, B, C, or any combination thereof means B only. In one embodiment, the terminology A, B, C, or any combination thereof means C only. In one embodiment, the terminology A, B, C, or any combination thereof means A and B only. In one embodiment, the terminology A, B, C, or any combination thereof means B and C only. In one embodiment, the terminology A, B, C, or any combination thereof means A and C only. In one embodiment, the terminology A, B, C, or any combination thereof means A, B, and C. Moreover, an embodiment can have a single A or a plurality of A. An embodiment can have a single B or a plurality of B. An embodiment can have a single C or a plurality of C.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference. It is to be expressly understood, however, that each of the figures is provided for the purpose of illustration and description only and is not intended as a definition of the limits of the present invention.

By way of non-limiting illustration, examples of certain embodiments of the present disclosure are given below.

### EXAMPLES

### Example 1: Preparation of PES Substrates

Materials and Methods

Casting Solution Preparation

The typical casting solution contains polyethersulfone (PES) polymer, hydrophilic additive, solvent, and pore forming agent. In the casting solution, polyvinylpyrrolidone (PVP) was used as a hydrophilic additive, 2-pyrrolidone (2PD) was employed as the solvent, and 2-methoxyethanol (2-ME) functioned not only as the pore forming agent but also as a cosolvent. The solubility was improved by the addition of 2-ME into 2PD. First, the casting solution was prepared by dissolving PES and PVP in an appropriate amount of 2-ME/2PD mixture at 60° C. for 12 hours under magnetic stirring. Then, the solution was stirred at room temperature until the solution was homogeneous. The homogeneous solution could be used for the subsequent casting. A typical PES content was 12 wt. % in the solution, while the PVP concentration was 0.1 wt. %, and the weight ratio of 2-ME to 2PD was 1.5.

Pilot-Scale Casting Process

Described are methods of making polymer substrates (e.g., polyethersulfone (PES)) with bicontinuous structure in pilot scale for membrane preparation for gas separation, such as CO₂ separation from flue gas. The resultant PES substrates with bicontinuous structure are an effective support for the fabrication of membranes for gas separations including the removal and capture of CO₂ from N₂-containing streams, e.g., flue gas in coal- and/or natural gas-fired power plants. It has also demonstrated the potential for the mass production of the PES substrates with bicontinuous structure through roll-to-roll fabrication.

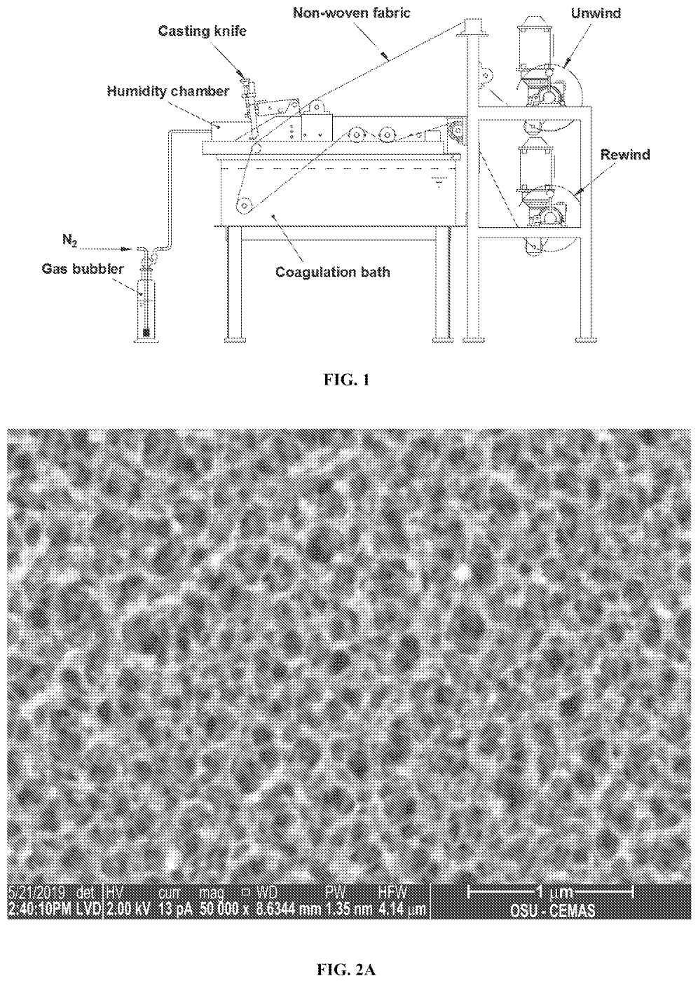

The nanoporous PES substrates were fabricated by vapor-induced phase separation (VIPS), followed by immersion in a nonsolvent, water. The PES substrate can be fabricated by employing a film applicator in lab scale or a continuous casting machine in pilot scale. The PES membrane was fabricated by a pilot-scale roll-to-roll casting machine, which is shown in FIG. 1. The casting solution was continuously cast onto the non-woven fabric moving at a speed of 1-5 ft/min by a stationary stainless-steel knife (up to 21-inch wide) with the pre-determined gap setting. A tension of 3-6 lb_{f} was applied to ensure the flatness of the fabric. The trough holding the casting solution was purged with N₂ at a sufficient flow rate (350 cc/min) to prevent the casting solution from phase separation. A humidity chamber was installed after the casting knife, and the rolling speed of the fabric could control the exposure time in the humidity chamber. Humid N₂ was flowed into the humidity chamber to control the relative humidity. The relative humidity and the exposure time in the humidity chamber were 20/6-95% and 1-50 seconds, respectively. Subsequently, the cast film was immersed into the water tank to form the PES substrate. The coagulation bath temperatures were controlled at 5-50° C.

Gas Transport Property Characterization

A permeation apparatus was assembled to measure the gas transport performance of the highly permeable substrate. The permeation apparatus was assembled using pure CO₂ (10 L/min, 1.5 psig) as the feed gas. The active membrane area was 6.4 cm². The temperature was controlled at 57° C. via a temperature-controlled oven (Bemco Inc. Simi Valley, Calif.). Both the permeate flow rate and the pressure on the permeate side were measured by a mass flow meter (Alicat Scientific, Tucson, Ariz., USA).

Compared to the substrates, the composite membranes were much less permeable, so the gas transport performances of composite membranes were characterized via a gas permeation testing apparatus equipped with a gas chromatograph (GC). The membrane was loaded into a rectangular stainless-steel cell with an effective area of 2.7 cm² and a countercurrent flow configuration. A feed gas mixture of 20% CO₂ and 80% N₂ on a dry basis and a sweep gas of argon (Ar) were controlled by the mass flow controllers (Brooks instrument, Hatfield, Pa.). The feed and sweep gas flow rate were 98 and 30 cc/min, respectively. Moreover, the pressures were adjusted to be 1.5 psig and 1.1 psig for feed and sweep side, respectively. The temperature was controlled at 57° C. via a temperature-controlled oven (Bemco Inc. Simi Valley, Calif.). The saturation water content of 17.2% at 57° C. (the typical flue gas temperature) were applied for both feed and sweep sides in all the transport experiments by humidifying the feed and sweep gases through stainless-steel humidifiers (Swagelok, Westerville, Ohio, U.S.A.) filled with Raschig glass ring packing. 100 ml water was pumped into the humidifier for both sides before the transport measurements. After the retentate and permeate gas streams were passed through their respective knockout vessels and dried by their respective drierite tubes, they were sent to a GC for composition analysis. Then, the gas compositions were used to determine CO₂ permeance and CO₂/N₂ selectivity.

Formulations

Sample 1—PES Substrate Prepared with 2-ME/2PD PES polymer (Ultrason® E7020P from BASF) and PVP (MW 360,000 Da from Sigma-Aldrich) were employed for the PES substrate preparation. The detailed casting solution composition is summarized in Table 1. A 2-ME/2PD weight ratio of 1.5 was used, corresponding to the 2-ME and 2PD concentrations in casting solution of 52.74 wt. % and 35.16 wt. %, respectively. The casting solution was prepared according to the aforementioned procedure, and the PES substrate was cast by the continuous casting machine shown in FIG. 1. The relative humidity was 70%, and the exposure time was 5.8 seconds. The water bath temperature was 22° C.

TABLE 1
Casting solution composition for the PES substrate in Sample 1.

| PES | PVP | |
|---|---|---|
| concentration | concentration | 2-ME/2PD |
| (wt. %) | (wt. %) | weight ratio |
| 12 | 0.1 | 1.5 |

Comparative Reference 1—PES Substrate Prepared with NMP/2-ME

PES substrate prepared with NMP as the solvent was employed as a comparative reference 1. The optimized PES concentration of 14 wt. %, PVP concentration of 0.1 wt. %, and NMP/2-ME weight ratio of 35/58 were applied. The similar solution preparation procedure and casting process described in Sample 1 were used. Table 3 shows the surface morphology and the CO₂ permeance of the optimized PES substrate prepared using NMP as the solvent. This substrate was used as a reference for showing the improvement of the PES substrate prepared using the solvent of 2PD/2-ME system.

Comparative Reference 2—PES Substrate Prepared with 2PD

PES substrate prepared using 2PD as the only solvent was employed as comparative reference 2. A PES concentration of 12 wt. %, a PVP concentration of 0.1%, and a 2PD concentration of 87.9 wt. % were employed. The similar solution preparation procedure and casting process described in Sample 1 were used. Table 4 shows the surface morphology and the CO₂ permeance of PES substrate prepared using 2PD as the only solvent. This substrate was used as a reference for showing the improvements of the PES substrate prepared using the solvent of 2PD/2-ME system.

Results

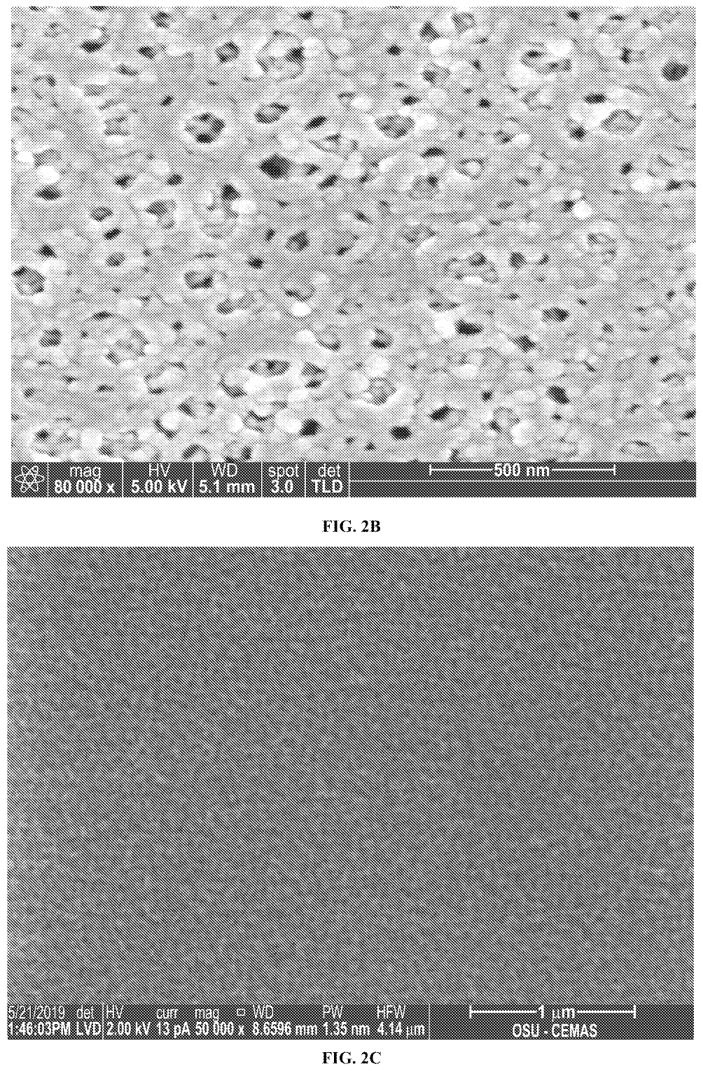

FIG. 2A shows the scanning electron microscopy (SEM) for the surface morphology of the PES substrate in Sample 1. The average pore size and surface porosity were 35.2 nm and 19.9%, respectively. For comparison, FIG. 2B is the SEM of the optimized PES substrate prepared using NMP as the solvent in comparative reference 1, indicating that the average pore size and surface porosity were 38.7 nm and 13.4%, respectively. In other words, the PES substrate had a 48.5% increase on the surface porosity via the use of the 2PD/2-ME system as the solvent. FIG. 2C is the SEM for the PES substrate prepared using 2PD as the only solvent in comparative reference 2, indicating that the average pore size and surface porosity were <10 nm and <5%, respectively. For comparison, the PES substrate showed a ˜300% increase on the surface porosity via the use of 2PD/2-ME system as the solvent.

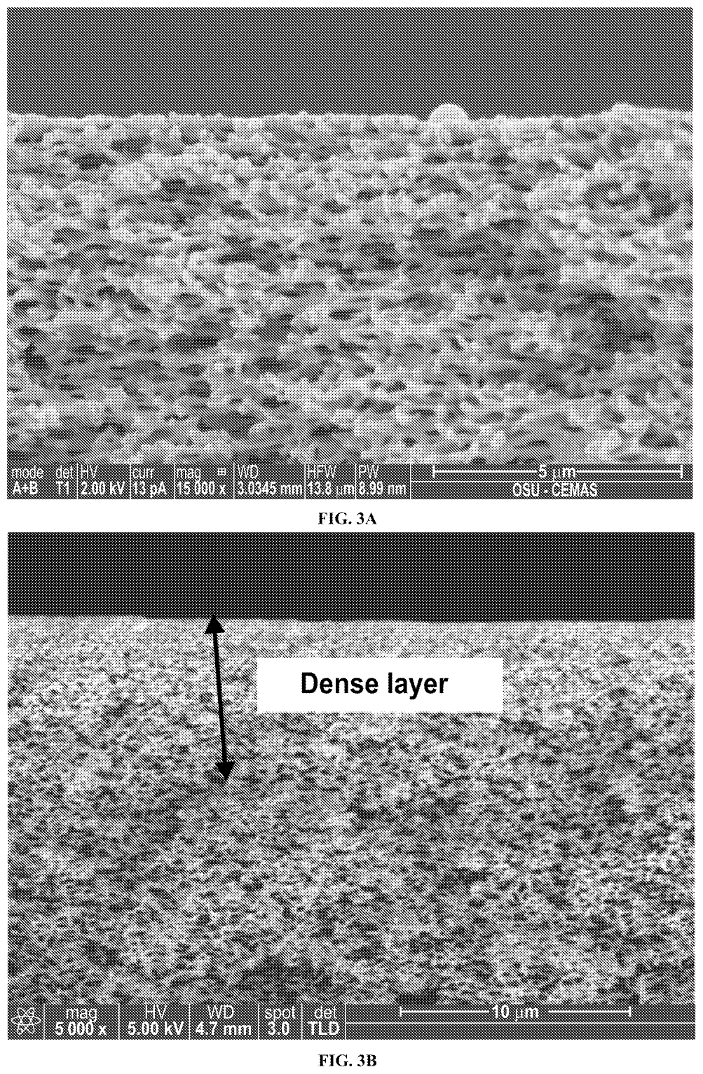

FIG. 3A shows the SEM for the cross-sectional morphology of the PES substrate in Sample 1. As seen, the pores were highly interconnected throughout the support, and no top dense layer was observed. The absence of a top dense layer is of great interest since it can contribute to a major mass transfer resistance to a polymer support. For comparison, FIG. 3B is the SEM for the cross-sectional morphology of the optimized PES substrate prepared using NMP as the solvent in comparative reference 1, indicating a dense layer of 8.5 μm. In other words, there was essentially no dense layer in the PES substrate via the use of the 2PD/2-ME system as the solvent.

Table 2 exhibits the substrate of Sample 1 with a CO₂ permeance of 133,226 GPU (1 GPU=10⁻⁶ cm³ (STP)·cm⁻²·s⁻¹·cmHg⁻¹).

TABLE 2
Summary of the transport result and surface
morphology of the PES substrate in Sample 1.

| Average | Surface | CO₂ |
|---|---|---|
| pore size | porosity | permeance |
| (nm) | (%) | (GPU) |
| 35.2 | 19.9 | 133,226 |

For comparison, Table 3 shows a CO₂ permeance of 22,000 GPU for the optimized PES substrate prepared using NMP as the solvent in comparative reference 1. Thus, the substrate of Sample 1 was 5 times more permeable than the optimized PES substrate prepared using NMP as the solvent (comparative reference 1).

TABLE 3
Summary of the transport result and surface morphology
of the PES substrate in Comparative reference 1.

| Average | Surface | CO₂ |
|---|---|---|
| pore size | porosity | permeance |
| (nm) | (%) | (GPU) |
| 38.7 | 13.4 | 22,000 |

For comparison, Table 4 gives a CO₂ permeance of 855 GPU for the PES substrate prepared using 2PD as the only solvent in comparative reference 2. Thus, the substrate of Sample 1 had more than 150 times higher permeance than the PES substrate prepared using 2PD as the only solvent (comparative reference 2). It is obvious that the increase on the surface porosity could not account for the improved permeance. Rather, the absence of a top dense layer and the presence of highly interconnected pores in the substrate were presumably the main contributors to the reduced mass transfer resistance in the substrate, resulting in such improved permeance.

TABLE 4
Summary of the transport result and surface morphology
of the PES substrate in Comparative Example 2.

| Average | Surface | CO₂ |
|---|---|---|
| pore size | porosity | permeance |
| (nm) | (%) | (GPU) |
| <10 nm | <5% | 855 |

Compared with the common solvent (e.g., N-methyl-2-pyrrolidone (NMP)) and 2PD only, the 2PD/2-ME system is more hydrophilic and can decrease the thermodynamic stability of the casting solution significantly. As a result, the phase separation during the membrane formation process was induced via spinodal decomposition mechanism. Compared with the PES substrate prepared with the common solvents, e.g., NMP or 2PD only, the PES substrate prepared with the 2PD/2-ME system as the solvent showed a much higher surface porosity and gas (e.g., CO₂) permeance.

### Example 2: PES Substrate with Bicontinuous Structure-Effect of Exposure Time

The casting solution was prepared by the same procedure described in Sample 1. The PES concentration, PVP concentration, and the 2-ME/2PD weight ratio were kept as 12 wt. %, 0.1 wt. %, and 1.5, respectively. The PES substrate with bicontinuous structure was obtained by using the casting process described in Sample 1, except the exposure time was controlled at 13.5 seconds. FIG. 4 shows the surface morphology of the prepared PES substrate, and Table 5 summarizes the surface morphology and the CO₂ permeance of the improved PES substrate with bicontinuous structure. As shown, the CO₂ permeance for the improved PES with bicontinuous structure in Example 2 (151,467 GPU) was more than 5.8 times higher than that of the optimized PES substrate prepared using NMP as the solvent in comparative reference 1 (22,000 GPU) and more than 175 times higher than that of the PES substrate prepared using 2PD as the only solvent in comparative reference 2 (855 GPU). The absence of a top dense layer and the presence of highly interconnected pores in the substrate were presumably the main contributors to the permeance improvements.

TABLE 5
Summary of the transport results and surface
morphology of the PES substrate in Example 2.

| Average | Surface | CO₂ |
|---|---|---|
| pore size | porosity | permeance |
| (nm) | (%) | (GPU) |
| 50.4 | 21.1 | 151,467 |

A bicontinuous structure is formed in a PES substrate, presumably due to both the increased solvent hydrophilicity and the reduced casting solution thermodynamic stability by the solvent system that induced the phase separation via spinodal decomposition mechanism. In the bicontinuous structure, the absence of a top dense layer and the presence of highly interconnected pores in the formed PES substrates reduced mass transfer resistance and enhanced the gas permeance significantly. The mass transfer resistance of the membrane is the sum of the resistance of each layer according to the resistance-in-series model. A more permeable substrate with higher porosity and smaller dense layer thickness will decrease the total mass transfer resistance of the composite membrane, thus increasing its gas (e.g., CO₂) permeance. Moreover, the surface morphology of the substrate affects the gas (e.g., CO₂) diffusion through the selective layer by introducing a lateral diffusion. A substrate with the higher surface porosity and pore density will decrease the lateral diffusion resistance and increase the gas (e.g., CO₂) permeance of the composite membrane. Moreover, by using these substrates with bicontinuous structure, the gas permeance of the prepared membrane can also be improved, presumably due to both the reduced lateral diffusion and substrate transport resistances.

### Example 3: PES Substrate with Bicontinuous Structure-Effect of Exposure Time and PES Concentration

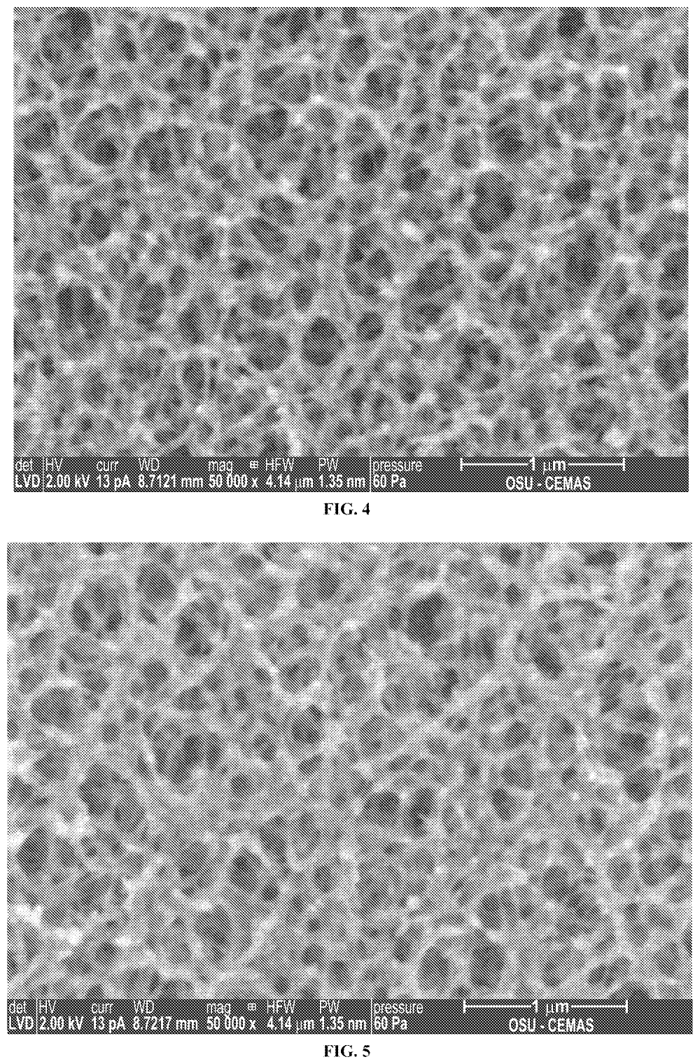

A PES substrate with bicontinuous structure was prepared by the same procedure described in Sample 1 except that a higher PES content was employed and the exposure time was controlled at 13.5 seconds. The detailed casting solution composition is summarized in Table 6. FIG. 5 shows the surface morphology of the prepared PES substrate, and Table 7 summarizes the surface morphology and the CO₂ permeance of the PES substrate of Example 3. As shown, the average pore size and surface porosity were 43.2 nm and 19.6%, respectively. Compared to comparative references 1 and 2, a more open morphology with bicontinuous structure was obtained as the CO₂ permeance of Example 3 was 128,330 GPU.

TABLE 6
Casting solution composition of the PES substrate in Example 3.

| PES | PVP | |
|---|---|---|
| concentration | concentration | 2-ME/2PD |
| (wt. %) | (wt. %) | weight ratio |
| 14 | 0.1 | 1.5 |

TABLE 7
Summary of the transport results and surface
morphology of the PES substrate in Example 3.

| Average | Surface | CO₂ |
|---|---|---|
| pore size | porosity | permeance |
| (nm) | (%) | (GPU) |
| 43.2 | 19.6 | 128,330 |

### Example 4: PES Substrate with Bicontinuous Structure-Effect of Exposure Time and Relative Humidity

The casting solution was prepared by the same procedure described in Sample 1. The PES concentration, PVP concentration, and the 2-ME/2PD weight ratio were kept as 12 wt. %, 0.1 wt. %, and 1.5, respectively. The PES substrate with bicontinuous structure was obtained by using the casting process described in Sample 1, except the relative humidity and the exposure time were controlled at 50% and 13.5 seconds, respectively. FIG. 6 shows the surface morphology of the prepared PES substrate, and Table 8 summarizes the surface morphology and the CO₂ permeance of the improved PES substrate. As shown, the CO₂ permeance of the improved PES in Sample 1 (133,684 GPU) was much higher than that of the optimized PES substrate prepared using NMP as the solvent in comparative reference 1 (22,000 GPU) and that of the PES substrate prepared using 2PD as the only solvent (855 GPU in comparative reference 2). The permeance improvements could be explained by the bicontinuous structure with well interconnected pores but no surface dense layer formation.

TABLE 8
Summary of the transport results and surface
morphology of the PES substrate in Sample 1.

| Average | Surface | CO₂ |
|---|---|---|
| pore size | porosity | permeance |
| (nm) | (%) | (GPU) |
| 37.8 | 20.1 | 133,684 |

### Example 5: PES Substrate with Bicontinuous Structure-Effect of Exposure Time and Coagulation Bath Temperature

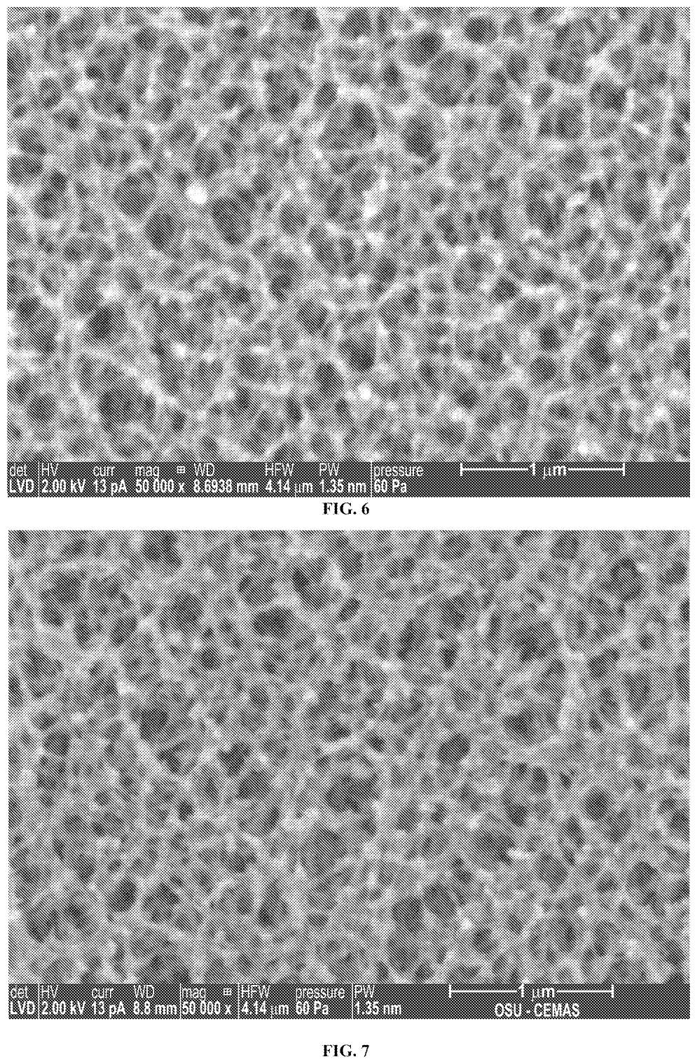

The casting solution was prepared by the same procedure described in Sample 1. The PES concentration, PVP concentration, and the 2-ME/2PD weight ratio were kept as 12 wt. %, 0.1 wt. %, and 1.5, respectively. The PES substrate with bicontinuous structure was obtained by using the casting process described in Sample 1, except the coagulation bath temperature and the exposure time were controlled at 24° C. and 13.5 seconds, respectively. FIG. 7 shows the surface morphology of the prepared PES substrate, and Table 9 summarizes the surface morphology and the CO₂ permeance of the prepared PES substrate. As shown, the CO₂ permeance of the improved PES substrate in Example 5 (152,214 GPU) was much higher than that of the optimized PES substrate prepared using NMP as the solvent in comparative reference 1 (22,000 GPU) and that of the PES substrate prepared using 2PD as the only solvent in comparative reference 2 (855 GPU). The permeance improvements could be attributed to the bicontinuous structure with well interconnected pores but no surface dense layer formation.

TABLE 9
Summary of the transport results and surface
morphology of the PES substrate in Example 5.

| Average | Surface | CO₂ |
|---|---|---|
| pore size | porosity | permeance |
| (nm) | (%) | (GPU) |
| 51.1 | 21 2 | 152,214 |

### Example 6: Preparation of Composite Membranes Using Sample 1, Comparative Reference 1, and Comparative Reference 2 Substrates

An amine-containing polymeric selective layer was coated on each substrate of Sample 1, comparative reference 1, and comparative reference 2, described earlier to form the composite membranes. The selective layer consisted of polyvinylamine (PVAm) serving as the fixed-site carrier and 2-(1-piperazinyl)ethylamine sarcosinate (PZEA-Sar) as the mobile carrier. PVAm and PZEA-Sar were mixed with a weight ratio of 35/65. A suitable viscosity of the coating solution (>1100 cp) was used to coat the selective layer on the substrate without defects. A selective layer thickness of ˜170 nm was employed for all the composite membranes. The gas transport properties of the composite membranes were measured by the procedure described previously. Table 10 lists the transport results of the prepared composite membranes by using the substrates fabricated from Examples 1, comparative reference 1, and comparative reference 2, respectively. As shown, the composite membrane coated on the substrate in Sample 1 yielded a CO₂ permeance of 908 GPU, which was 48 GPU higher than that of the composite membrane coated on the substrate in comparative reference 1 and 841 GPU higher than that of the composite membrane coated on the substrate in comparative reference 2. The CO₂/N₂ selectivity of the composite membrane coated on the substrate in Sample 1 was 162, which was slightly higher that of composite membrane coated on the substrate in comparative reference 1 and much higher than that of the composite membrane coated on the substrate in comparative reference 2. The improved CO₂ permeance of the thin-film composite membrane was presumably attributed to both the reduced lateral diffusion and substrate transport resistances.

TABLE 10
Separation performances of the composite membranes
with the substrates fabricated from Examples 1, comparative
reference 1, and comparative reference 2.

| | | CO₂ | |
|---|---|---|---|
| Membrane | | permeance | CO₂/N₂ |
| No. | Substrate | (GPU) | selectivity |
| 1 | Sample 1 | 908 | 162 |
| 2 | comparative | 860 | 160 |
| | reference 1 | | |
| 3 | comparative | 67 | 128 |
| | reference 2 | | |

### Example 7: Preparation Sterically Hindered Polyvinylamine Membranes

Disclosed are the improved synthesis approach of a high-molecular-weight sterically hindered polyvinylamine (SH-PVAm) and the application of the improved SH-PVAm as the new fixed-site carrier used in membranes for CO₂ separation and capture. The CO₂-selective membranes of both high CO₂ permeability and high CO₂/N₂ selectivity are required to realize cost-effective CO₂ capture in the large-scale application, including post-combustion CO₂ capture from flue gas in coal- and/or natural gas-fired power plants. The SH-PVAm membranes containing 2-(1-piperazinyl)ethylamine sarcosinate as the mobile carrier were successfully prepared, and they demonstrated significantly improved CO₂ separation performances vs. the membranes containing conventional polyvinylamine at 57° C.

Background

Membrane based-CO₂ capture from flue gas is considered to be a potentially practical solution to CO₂ emission due to its inherent advantages, e.g., high energy efficiency, operational simplicity, cost-effectiveness, and environmental friendliness [1,2]. However, for the conventional polymeric membranes, Robeson has demonstrated via the upper bond approach that there is the trade-off between CO₂ permeability and CO₂/N₂ selectivity, i.e., there is a maximum CO₂/N₂ selectivity corresponding to an obtained membrane CO₂ permeability [3-5]. Facilitated transport membrane (FTM), e.g., amine-containing membrane, on the other hand, is one of the state-of-art membranes which can circumvent the constraint [6,7]. With the incorporated amine-containing carriers in the membrane, FTM can reach both high CO₂ permeance and high CO₂/N₂ selectivity at the same time benefiting from the reversible reaction between the carriers and CO₂. In FTM, CO₂ molecules first dissolve and react with the amine in the membrane, and the resulting products move via diffusion from the high-pressure side (feed side) to the low-pressure side (permeate side) of the membrane. On the contrary, a N₂ molecule cannot react with the amine in the membrane and therefore is rejected by the membrane; its exclusive permeation pathway through the membrane is by the solution-diffusion mechanism, resulting in a very low N₂ permeation rate. There are two types of amine-containing carriers used in FTM, fixed-site carrier and mobile carrier. Fixed-site carrier is the amine functional group covalently bonded to the polymer backbone, and its mobility is through the hoping mechanism from one amino site on the high molecular weight of the polymer to the next amino site. Mobile carrier is the small amine of low molecular weight or its derivative, which can move across the membrane.

Based on the mechanism of FTM, the CO₂ separation performance of FTM is largely affected by the types of amine carriers used. Among the aliphatic amines, primary and secondary amines are more advantageous than tertiary amines for CO₂ capture at low CO₂ partial pressure due to their faster reaction rates and the resulting higher efficiency. For primary and secondary amines, the CO₂-amine reaction chemistry is widely described by the zwitterion mechanism as follows:

CO₂+R—NH₂ [symbol] R—NH₂⁺—COO⁻

R—NH₂⁺—COO⁻+R—NH₂ [symbol] R—NH—COO⁻+R—NH₃⁺

An unhindered amine can function as a nucleophile to attack CO₂ to form a zwitterion, which is then rapidly deprotonated by another free amine to generate a more stable carbamate [8]. Overall, 2 moles of amine are needed for 1 mole of CO₂.

On the other hand, sterically hindered amine follows another reaction route due to the steric hindrance effect of the additional bulky group. A sterically hindered amine is defined as either a primary amine in which the amino group is attached to a tertiary carbon or a secondary amine in which the amino group is attached to at least one secondary or tertiary carbon [9,10]. For sterically hindered amine, the formed carbamate is not stable and easily hydrolyzed by water, resulting in the formation of bicarbonate and the regeneration of an amine:

CO₂+R₁—NH—R₂ [symbol] R₁R₂—NH—COO⁻

R₁R₂—NH⁺—COO⁻+H₂O [symbol] R₁R₂−NH₂⁺+HCO₃⁻

Overall, each mole of amine can capture 1 mole of CO₂. Therefore, the use of blended sterically hindered amine species in the CO₂-selective membranes is attractive because of the advantages mentioned above. First, a significantly higher reaction kinetics compared to tertiary amines. Second, the theoretically doubled CO₂ loading capacity than that of primary and secondary amines.

Sterically hindered small-molecule amines have been studied quite extensively in aqueous amine solutions for acid-gas absorption and in amine-containing mobile carriers used in membranes, for example, 2-amino-2-methyl-1-propanol (AMP) and potassium salt of 2-aminoisobutyric acid (AIBA-K), respectively [9,11]. High-molecular-weight polyamines, e.g., polyallylamine (PAA) and polyvinylamine (PVAm) were also modified for achieving improved CO₂ separation performances previously in our group [12-14]. Among these high-molecular-weight sterically hindered polyamines, poly(N-methyl-N-vinylamine) showed 24% and 14% improvements in CO₂ permeability and in CO₂/N₂ selectivity, respectively.

An improved method for the synthesis of poly(N-methyl-N-vinylamine) and the use of the improved poly(N-methyl-N-vinylamine) synthesized as the fixed-site carrier for successful preparation of an ultra-thin membrane (with a thickness of 170 nm) containing 2-(1-piperazinyl)ethylamine sarcosinate (PEZA-Sar) as the mobile carrier is described.

Materials and Methods

Commercial high-molecular-weight copolymer poly(N-vinylformamide-co-vinylamine) (PNVF-co-VAm), Polymin® VX from BASF (Vandalia, Ill.) was selected as the starting polymer for the improved synthesis of poly(N-methyl-N-vinylamine). Polymin® VX was purified as described in Y. Han, et al., J. Membr. Sci., 567 (2018) 261-271. The nanoporous polysulfone support and the nanoporous polyethersulfone support used in the membrane preparation were purchased from Microdyn-Nadir US Inc. (Goleta, Calif., USA) and fabricated in our laboratory as described in the previous study D. Wu, Y. et al., J. Membr. Sci., 565 (2018) 439-449, respectively. All the other chemicals were used as received without any further purification.

Nuclear Magnetic Resonance (NMR)

The NMR sample was prepared by dissolving the SH-PVAm·HCl in D₂O at the concentration of 1 wt. %. The ¹H NMR spectra were recorded using a Bruker Avance III 400 MHz spectrometer (Bruker Corporation, Billerica, Mass.) at 25° C. The D₂O resonance (δ=4.79 ppm) was used as an internal reference.

Gas Transport Measurement

Membrane separation performance was measured in a custom-built gas permeation unit shown in FIG. 8. The apparatus allowed the measurement of a membrane coupon with an effective permeation area of 2.7 cm². The composite membrane was loaded into an air-tight permeation cell with counter-current feed and sweep gases. The feed gas comprised 20% CO₂ and 80% N₂ (on dry basis), and the sweep gas was argon. Both gas streams passed through respective humidifiers to achieve the saturated water vapor content of 17.2%. The oven was set at 57° C. to simulate the typical temperature of the flue gas. The retentate and permeate streams coming out of the cell went through their respective water vapor knockout vessels and were analyzed by an Agilent 6890N gas chromatograph (Agilent Technologies, Palo Alto, Calif.).

The membrane transport performances in terms of permeability Pᵢ and selectivity αᵢⱼ are defined as follows [2]:

$${P}_{i} = \frac{{J}_{i}}{Δ {p}_{i} / l} \qquad 1 )$$

$${α}_{ij} = \frac{{y}_{i} / {y}_{j}}{{x}_{i} / {x}_{j}} \qquad 2 )$$

$$Δ {p}_{i} = \frac{( {p}_{i , feed i n} - {p}_{i , sweep out} ) - ( {p}_{i , feed out} - {p}_{i , sweep i n} )}{ln ( {p}_{i , feed i n} - {p}_{i , sweep out} ) - ln ( {p}_{i , feed out} - {p}_{i , sweep i n} )} \qquad 3 )$$

where i denotes the gas component CO₂ and j denotes N₂; y and x are the mole fractions of each gas component in the sweep and feed streams, respectively; Jᵢ is the steady-state CO₂ molar flux across the membrane; l is the thickness of the selective layer; Δpᵢ is the pressure differential of CO₂ across the membrane. Furthermore, the common unit of the permeability Pᵢ is Barrer, which has a unit of 10⁻¹⁰ cm³ (STP) cm cm⁻² s⁻¹ cmHg¹. The ratio of the permeability to the selective layer thickness (Pᵢ/l) is defined as the permeance, which is expressed in terms of the gas permeation unit (GPU, 1 GPU=10⁻⁶ cm³ (STP) cm⁻² s⁻¹ cmHg⁻¹).

Membrane Synthesis

The coating solution used for preparation of the selective layer was obtained by blending an aqueous solution of sterically hindered polyvinylamine (SH-PVAm) and an aqueous solution of 2-(1-piperazinyl)ethylamine sarcosinate (PZEA-Sar). The SH-PVAm solution was first concentrated by nitrogen purge for obtaining the coating solution with a sufficient viscosity ˜1400 cp. PZEA-Sar was prepared by mixing stoichiometric sarcosine with 24 wt. % 2-(1-piperazinyl)ethylamine aqueous solution for a resulting solution of 34 wt. % in water. The prepared PZEA-Sar solution was added to the SH-PVAm solution under stirring until the resulting solution became homogeneous. The resulting coating solution was coated onto the PES substrate by GARDCO film applicator (Paul N. Gardner Company, Pompano Beach, Fla., USA). The membrane was transferred immediately to a fume hood and dried overnight before testing. The thickness of the substrate was measured by a Mitutoyo electronic indicator Model 543-252B (Mitutoyo America Corp, Aurora, Ill., USA) with an accuracy of +0.5 μm. The thickness of the selective layer was characterized by scanning electron microcopy (SEM, FEI Nova 400 NanoSEM, Hillsboro, Oreg., USA) followed by the image analysis using the Clemex Vision Professional Edition (Longueuil, Quebec, Canada) software.

### Example 8: Synthesis of SH-PVAm: Effect of Different Reaction Temperatures

The purified polyvinylamine was acid hydrolyzed to increase the amine content before its use in the improved synthesis of sterically hindered polyvinylamine.

Acidic Hydrolysis of Polyvinlyamine

The purified polyvinylamine was acid hydrolyzed by hydrochloric acid at 80° C. for 5 hours to have an amino/amide mole ratio of ca. 90/10, followed by the precipitation in ethanol and drying in the vacuum oven at 50° C. overnight. The obtained polymer was dissolved in water, and then ion-exchanged by Purolite® A600OH strong base anion-exchange resin (Purolite Corporation, Bala Cynwyd, Pa.) to have a solution of pH 11-12.

Synthesis of the Sterically Hindered Polyvinylamine

The obtained polymer solution was first dried by nitrogen purge to remove most of the water and then further dried in the vacuum oven at room temperature overnight before its use in the improved synthesis of sterically hindered polyvinylamine. A solution of the polymer dissolved in hexafluoro-2-propanol at 50° C. with a water reflux overnight was cooled to room temperature. Then, paraformaldehyde (1.0 equiv.) was added, and the solution was heated at the reaction temperature for 20 hours. The solution was carefully treated with excess NaBH₄ (2.0 equiv.) with cooling in an ice bath and allowed to stir overnight to room temperature. After the reaction was completed, the reaction mixture was quenched with 3M HCl (aq.) to a pH value of ˜2. The mixture was pulled into acetone, and the precipitated polymer was re-dissolved in water. The purification was repeated 2 times to remove the most impurities and salts. The resulting polymer solution was heated at 65° C. and purged by nitrogen for 10 minutes to remove trace hexafluoro-2-propanol. The solution is then allowed to cool to room temperature and poured into acetone to precipitate the polymer. The polymer was dried in the vacuum oven at 50° C. overnight and then was dissolved in water to form a 3 wt. % solution. The solution was dialyzed exhaustively using a 12 kDa dialysis membrane, followed by the strong base anion-exchange which was previously described to a solution of pH11-12.

Characterization of the Synthesized Sterically Hindered Polyvinylamine

The synthesized sterically hindered polyvinylamine (SH-PVAm) was characterized by proton nuclear magnetic resonance spectroscopy (¹H NMR) as described in Example 7.

The N-methylation degree was largely affected by the reaction conditions, including reaction temperature, types of methylating agent and solvent, and PVAm solution concentration.

The degree of N-methylation of SH-PVAm was determined from the integral area ratio of the N-methyl group peak to that of the N-methylene group in Equation 4 as follows:

$$N ‐ methylation degree = \frac{2 \times ( N - methyl group peak area )}{3 \times ( N - methyl group peak area )} \qquad ( 4 )$$

The results of the synthesized SH-PVAm conducted at different reaction temperatures are shown in Table 11. The N-methylation degree of 33% could be obtained when the synthesis was conducted at 45° C.

TABLE 11
The N-methylation degree of the SH-PVAm
at different reaction temperatures.

| | Reaction | |
|---|---|---|
| | Temperature | N-methylation |
| SH-PVAm | (° C.) | Degree (%) |
| T1 | Room temperature | N/A |
| T2 | 40 | 31 |
| T3 | 45 | 33 |
| T4 | 55 | 30 |

The reactions were carried out in 1.0 wt. % PVAm solution in HFIP using 1.0 equivalent paraformaldehyde.

### Example 9: Synthesis of SH-PVAm: Effect of Different Methylating Agents

The synthesis procedure was like that described in Example 8, except that formalin or paraformaldehyde was used as the methylating agent in 1 or 2 wt. % PVAm solution in HFIP. The characterization method was the same as in Example 8. The results of the synthesis conducted using different methylating agents are shown in Table 12. The N-methylation degree was higher when paraformaldehyde was used as the methylating agent in both 1 and 2 wt. % PVAm solutions.

TABLE 12
The N-methylation degrees of the SH-PVAm
using different methylating agents.

| | | PVAm | N-methylation |
|---|---|---|---|
| | | Concentration | Degree |
| SH-PVAm | Methylating Agent | (wt. %) | (%) |
| M1 | Formalin^{(a)} | 1.0 | 18 |
| M2 | Paraformaldehyde | 1.0 | 33 |
| M3 | Formalin^{(b)} | 2.0 | 20 |
| M4 | Paraformaldehyde | 2.0 | 39 |

^{(a)}1.2 equivalent of formalin* was used,
^{(b)}The reactions were carried out at 45° C., except M3 at room temperature. *Formalin used was formaldehyde solution of 37 wt. % in H₂O with 10-15% methanol as stabilizer.

### Example 10: Synthesis of SH-PVAm: Effect of Different Solvents

The synthesis procedure was like that described in Example 8, except that different aprotic solvents were used, and the reaction temperatures were adjusted based on the solubility of PVAm in these solvents. The characterization method was the same as in Example 8. The results of the synthesis conducted using different solvents are shown in Table 13. Among the solvents that could give homogeneous PVAm solutions, the N-methylation degree was much higher when HFIP was used.

TABLE 13
The N-methylation degree of the
SH-PVAm using different solvents.

| | | Reaction | N-methylation |
|---|---|---|---|
| | | Temperature | Degree |
| SH-PVAm | Solvent | (° C.) | (%) |
| S1 | HFIP | 45 | 33 |
| S2 | TFE* | 65 | 26 |
| S3 | HFIP/MeOH = 50/50 | 55 | 9 |
| S4 | HFIP/water = 95/5 | 55 | 18 |

The reactions were carried out at in 1.0 wt. % PVAm solution in respective solvents using 1.0 equivalent paraformaldehyde. *TFE=Trifluoroethanol

PVAm was mono-methylated by the stepwise reductive amination in a fluorinated alcohol, hexafluoro-2-propanol (HFIP). Due to the introduction of highly electronegative fluorine atoms, HFIP is a very strong hydrogen bond donor [15,16]. Because of the hydrogen bonding property, HFIP was found as the one of the few solvents which can dissolve the high-molecular-weight PVAm except water. The anhydrous environment was advantageous for the equilibrium shift to the imine formation, which resulted in a higher N-methylation degree. The strong inductive effect of fluorine also results in the enhanced acidity, which may also promote the depolymerization of paraformaldehyde into formaldehyde.

### Example 11: Synthesis of SH-PVAm: Effect of PVAm Solution Concentrations in HFIP

The synthesis procedure was like that described in Example 8, except that the PVAm solutions of different concentrations in HFIP were used. The characterization method was the same as in Example 8. The results of the syntheses conducted in the PVAm solutions of different concentrations in HFIP are shown in Table 14. The 2 wt. % PVAm solution in HFIP could give the highest N-methylation degree of 39% for the synthesis of SH-PVAm.

TABLE 14
The N-methylation degrees of the SH-PVAm using PVAm
solutions of different concentrations in HFIP.

| | PVAm | |
|---|---|---|
| | Concentration | N-methylation |
| SH-PVAm | in HFIP (wt. %) | Degree (%) |
| C1 | 1.0 | 33 |
| C2 | 2.0 | 39 |
| C3 | 3.0 | 30 |

The reactions were carried out at 45° C. using 1.0 equivalent paraformaldehyde in HFIP.

### Example 12: Sterically Hindered Polyvinylamine Membranes: Effect of the Degree of Steric Hindrance in Membranes with Mobile Carrier

The sterically hindered polyvinylamine membranes were prepared as described in Example 7. The solutions of SH-PVAm of 33% and 39% N-methylation degrees were concentrated by nitrogen purge to 4.8 wt. % and 6.0 wt. %, respectively, and then blended with PEZA-Sar with a weight ratio of 35/65 to form the selective-layer coating solution. The membranes were tested according to the procedure described in the Example 7. The membrane transport performances are shown in Table 15. As the N-methylation degree of the SH-PVAm increased from 33% (M-1) to 39% (M2), the membrane showed an improved performance from 879.7 GPU to 925.3 GPU in CO₂ permeance and 163.7 to 166.0 in CO₂/N₂ selectivity at 57° C.

TABLE 15
The performances of the sterically
hindered polyvinylamine membranes.

| | N-methylation | CO₂ | |
|---|---|---|---|
| | degree of | Permeance | CO₂/N₂ |
| Membrane | SH-PVAm | (GPU) | Selectivity |
| M-1 | 33 | 879.7 | 163.7 |
| M-2 | 39 | 925.3 | 166.0 |

* For comparison, the PVAm membrane with 65 wt. % PZEA-Sar showed 759 GPU in CO₂ permeance and 163 in CO₂/N₂ selectivity.

### Example 13: Sterically Hindered Polyvinylamine Membranes: Effect of Steric Hindrance in Membranes with Different Amounts of Mobile Carrier

The sterically hindered polyvinylamine membranes were prepared as described in Example 7. The SH-PVAm solution of 39% N-methylation degree was concentrated by nitrogen purge to 6.0 wt. %, and then blended with PEZA-Sar with weight ratios of 35/65 and 15/85 to form the selective-layer coating solutions. The membranes were tested according to the procedure described in the Example 7. The membrane transport performances are shown in Table 16. As the amount of PZEA-Sar increased from 65% (M-1) to 85% (M2), the membrane showed a higher CO₂ performance from 925.3 GPU to 1071.0 GPU in CO₂ permeance and a higher CO₂/N₂ selectivity from 166.0 to 182.7. Compared with the PVAm membrane with 85 wt. % PZEA-Sar, M-2 membrane showed significant improvements in CO₂ permeance by 96 GPU and in CO₂/N₂ selectivity by 19.7 at 57° C.

TABLE 16
The performances of the sterically
hindered polyvinylamine membranes.

| | N-methylation | | CO₂ | |
|---|---|---|---|---|
| | degree of | PZEA-Sar | Permeance | CO₂/N₂ |
| Membrane | SH-PVAm | (wt. %) | (GPU) | Selectivity |
| M-1 | 39 | 65 | 925.3 | 166.0 |
| M-2 | 39 | 85 | 1071.0 | 182.7 |

* For comparison, the PVAm membrane with 85 wt. % PZEA-Sar showed 975 GPU in CO₂ permeance and 163 in CO₂/N₂ selectivity.

The reaction conditions for the synthesis of SH-PVAm with the N-methylation degree of 39% incorporated with 85 wt. % PEZA-Sar demonstrated an effective CO₂/N₂ separation performance with a CO₂ permeance of 1071 GPU and a CO₂/N₂ selectivity of 183.

### Example 14: Sterically Hindered Polyvinylamine Membranes: Effect of Steric Hindrance

The solutions of PVAm and SH-PVAm of 39% N-methylation degree were concentrated by nitrogen purge to 4.0 wt. % and 4.5 wt. %, respectively. Next, the polymer solutions were coated onto the commercial polysulfone substrates (surface pore size of 9 nm) by GARDCO film applicator (Paul N. Gardner Company, Pompano Beach, Fla., USA). The gap setting of the coating knife was controlled to achieve a dried selective layer thickness of about 3.5 micron. The membrane was transferred immediately to the fume hood and dried overnight before testing. The thickness of the substrate was measured by a Mitutoyo electronic indicator Model 543-252B (Mitutoyo America Corp, Aurora, Ill., USA) with an accuracy of ±0.5 μm. The membranes were tested according to the procedure described in the Example 7. The membrane transport performances are shown in Table 17. Compared to the PVAm membrane, the SH-PVAm membrane with 39% N-methylation degree showed an improved performance from 337.3 Barrer to 445.7 Barrer in CO₂ permeability and 45.7 to 70.3 in CO₂/N₂ selectivity at 57° C.

TABLE 17
The comparison of PVAm and SH-
PVAm membrane performances.

| | | CO₂ | |
|---|---|---|---|
| | N-methylation | Permeability | CO₂/N₂ |
| Membrane | degree | (Barrers) | Selectivity |
| PVAm | 0 | 337.3 | 45.7 |
| SH-PVAm | 39 | 445.7 | 70.3 |

### REFERENCE

[1] A. S. Bhown, B. C. Freeman, Analysis and Status of Post-Combustion Carbon Dioxide Capture Technologies, Environmental Science & Technology, 45 (2011) 8624-8632.
[2] W. S. W. Ho, K. K. Sirkar, Membrane Handbook, Springer Science & Business Media, 2012.
[3] L. M. Robeson, Correlation of Separation Factor versus Permeability for Polymeric Membranes, Journal of Membrane Science, 62 (1991) 165-185.
[4] L. M. Robeson, The Upper Bound Revisited, Journal of Membrane Science, 320 (2008)
390-400.
[5] H. B. Park, J. Kamcev, L. M. Robeson, M. Elimelech, B. D. Freeman, Maximizing the Right Stuff: The Trade-Off Between Membrane Permeability and Selectivity, Science, 356 (2017) eaab0530.
[6] J. Huang, J. Zou, W. S. W. Ho, Carbon Dioxide Capture Using a CO₂—Selective Facilitated Transport Membrane, Industrial & Engineering Chemistry Research, 47 (2008) 1261-1267.
[7] Z. Tong, W. S. W. Ho, Facilitated Transport Membranes for CO₂ Separation and Capture, Separation Science and Technology, 52 (2017) 156-167.
[8] M. Caplow, Kinetics of Carbamate Formation and Breakdown, Journal of the American Chemical Society, 90 (1968) 6795-6803.
[9] G. Sartori, W. S. W. Ho, D. W. Savage, G. R. Chludzinski, S. Wlechert, Sterically-Hindered Amines for Acid-Gas Absorption, Separation and Purification Methods, 16 (1987) 171-200.
[10] G. Sartori, D. W. Savage, Sterically Hindered Amines for CO₂ Removal from Gases, Industrial & Engineering Chemistry Fundamentals, 22 (1983) 239-249.
[11] J. Zou, W. S. W. Ho, CO₂—Selective Polymeric Membranes Containing Amines in Crosslinked Poly (Vinyl Alcohol), Journal of Membrane Science, 286 (2006) 310-321.
[12] Y. Zhao, W. S. W. Ho, Steric Hindrance Effect on Amine Demonstrated in Solid Polymer Membranes for CO₂ Transport, Journal of Membrane Science, 415 (2012) 132-138.
[13] Y. Zhao, W. S. W. Ho, CO₂—Selective Membranes Containing Sterically Hindered Amines for CO₂/H₂ Separation, Industrial & Engineering Chemistry Research, 52 (2013) 8774-8782.
[14] Z. Tong, W. S. W. Ho, New Sterically Hindered Polyvinylamine Membranes for CO₂ Separation and Capture, Journal of Membrane Science, 543 (2017) 202-211.
[15] I. Colomer, A. E. Chamberlain, M. B. Haughey, T. J. Donohoe, Hexafluoroisopropanol as A Highly Versatile Solvent, Nature Reviews Chemistry, 1 (2017) 1-12.
[16] T. Lebleu, X. Ma, J. Maddaluno, J. Legros, Selective Monomethylation of Primary Amines with Simple Electrophiles, Chemical Communications, 50 (2014) 1836-1838.
[17] Y. Han, D. Wu, W. S. W. Ho, Nanotube-Reinforced Facilitated Transport Membrane for CO₂/N₂ Separation with Vacuum Operation, Journal of Membrane Science, 567 (2018) 261-271.
[18] D. Wu, Y. Han, W. Salim, K. K. Chen, J. Li, W. S. W. Ho, Hydrophilic and Morphological Modification of Nanoporous Polyethersulfone Substrates for Composite Membranes in CO₂ Separation, Journal of Membrane Science, 565 (2018) 439-449.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A membrane comprising:
a base,
a support layer comprising a gas permeable polymer disposed on the base, wherein the support layer has a CO₂ permeance of at least 25,000 GPU at 57° C. and ambient pressure; and
a selective polymer layer disposed on the support layer, the selective polymer layer comprising a selective polymer matrix.

2. The membrane of claim 1, wherein the support layer further comprises a hydrophilic additive and is prepared from a casting solution comprising a gas permeable polymer, a hydrophilic additive, a solvent, a pore forming agent, or a combination thereof.

3. The membrane of claim 1, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

4. (canceled)

5. The membrane of claim 1, wherein the support layer has a bicontinuous structure.

6. The membrane of claim 2, wherein the hydrophilic additive comprises polyvinylpyrrolidone, polyvinylalcohol, a polyalkylene oxides, such as polyethylene oxide, polypropylene oxide, and copolymers thereof, surfactants, inorganic additives, hydrophilically-modified carbon nanotubes, graphene oxide, zeolites, and combinations thereof.

7-10. (canceled)

11. The membrane of claim 1, wherein the support layer has a CO₂ permeance of from 25,000 GPU to 200,000 GPU at 57° C. and ambient pressure.

12. The membrane of claim 1, wherein the selective polymer matrix comprises a hydrophilic polymer, a cross-linking agent, an amino compound, a CO₂-philic ether, or a combination thereof.

13. The membrane of claim 1, wherein the selective polymer matrix comprises an amino compound, wherein the amino compound comprises an amine-containing polymer.

14. (canceled)

15. (canceled)

16. The membrane of claim 13, wherein the amine-containing polymer comprises a sterically hindered derivative of polyvinylamine;
wherein the sterically hindered derivative of polyvinylamine comprises:
a polymer having the structure below 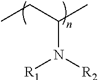
wherein
R₁ and R₂ are, independently for each occurrence, hydrogen, alkyl, alkenyl, alkynl, aryl, or cycloalkyl, or R₁ and R₂, together with the nitrogen atom to which they are attached, form a hetercyclic ring, with the provisio that at least one of R₁ and R₂ is not hydrogen; and
n is an integer from 10 to 25,000;
a random copolymer or block copolymer having the structure below 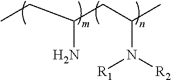
wherein
R₁ and R₂ are, independently for each occurrence, hydrogen, alkyl, alkenyl, alkynyl, aryl, or cycloalkyl, or R₁ and R₂, together with the nitrogen atom to which they are attached, form a hetercyclic ring, with the provisio that at least one of R₁ and R₂ is not hydrogen;
m is an integer from 10 to 10,000; and
n is an integer from 10 to 10,000; or
a random copolymer or block copolymer having the structure below 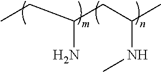
wherein
m is an integer from 10 to 10,000; and
n is an integer from 10 to 10,000.

17-23. (canceled)

24. The membrane of claim 16, wherein the sterically hindered amine-containing polymer exhibits a degree of N-methylation degree of from 20% to 50%.

25-28. (canceled)

29. The membrane of claim 12, wherein the amino compound comprises a low molecular weight amino compound.

30. (canceled)

31. (canceled)

32. The membrane of claim 29, wherein the low molecular weight amino compound comprises a salt defined by a general formula below 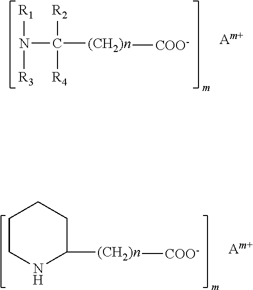
wherein R₁, R₂, R₃, and R₄ are hydrogen or hydrocarbon groups having from 1 to 4 carbon atoms, n is an integer ranging from 0 to 4, and A^{m+} is a cation having a valence of 1 to 3, and m is an integer equal to the valence of the cation.

33. (canceled)

34. The membrane of claim 29, wherein the low molecular weight amino compound comprises an amino acid salt;
wherein the amino acid salt is defined by the formula below 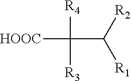
wherein, independently for each occurrence in the amino acid, each of R₁, R₂, R₃ and R₄ is selected from one of the following 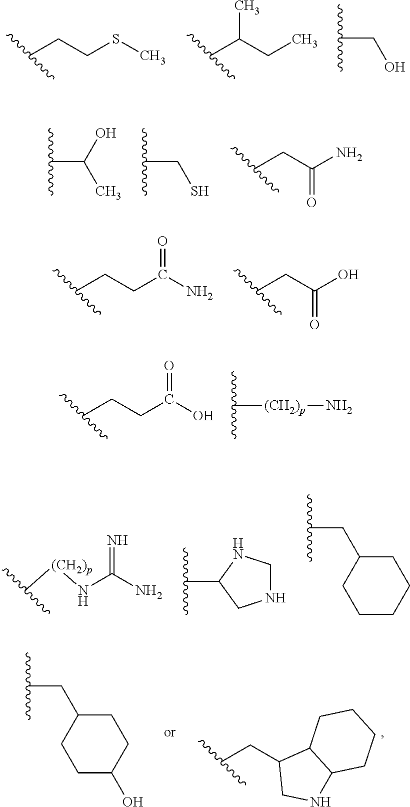
wherein
at least one of R₁-R₄ comprises an amino group and p, when present, is an integer from 1 to 4;
or R₁ and R₃, together with the atoms to which they are attached, form a five-membered heterocycle defined by the structure below when n is 1, or a six-membered heterocycle defined by the structure below when n is 2

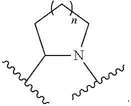

35-38. (canceled)

39. The membrane of claim 12, wherein the cross-linking agent comprises a compound selected from the group consisting of aminosilane, formaldehyde, glutaraldehyde, maleic anhydride, glyoxal, divinylsulfone, toluenediisocyanate, trimethylol melamine, terephthalatealdehyde, epichlorohydrin, vinyl acrylate, and combinations thereof.

40-42. (canceled)

43. The membrane of claim 12, wherein the hydrophilic polymer comprises a crosslinked hydrophilic polymer.

44-58. (canceled)

59. The membrane of claim 1, wherein the selective polymer matrix has a CO₂:N₂ selectivity of from 50 to 500 at 57° C. and 1 bar feed pressure.

60. (canceled)

61. The membrane of claim 1, wherein the membrane exhibits a CO₂ permeance of from 100 to 4,000 GPU at 57° C. and 1 atm feed pressure.

62-77. (canceled)

78. A method for separating a first gas from a feed gas stream, the method comprising contacting a membrane defined by claim 1 with the feed gas stream comprising the first gas under conditions effective to afford transmembrane permeation of the first gas.

79-85. (canceled)

86. A membrane comprising:
a support layer; and
a selective polymer layer disposed on the support layer, the selective polymer layer comprising a selective polymer matrix that comprises a sterically hindered amine-containing polymer,
wherein the sterically hindered amine-containing polymer comprises from 5 to 50 mol % secondary amine-containing monomers, based on the total of all amine-containing monomers in the amine-containing polymer.

87-113. (canceled)
